(19) United States
(12) Patent Application Publication
(10) Pub. No.: US 2005/0257130 A1
(43) Pub. Date: Nov. 17, 2005

(54) User terminal, display data generation method, and computer program

(76) Inventor: Akihiko Ito, Tokyo (JP)

Correspondence Address: FROMMER LAWRENCE & HAUG LLP, 745 FIFTH AVENUE, NEW YORK, NY, 10151, US

(21) Appl. No.: 11/127,981

(22) Filed: May 12, 2005

(30) Foreign Application Priority Data
May 14, 2004 (JP) P2004-145357

(51) Int. Cl. G06F 17/00

(52) U.S. Cl. 715/500.1; 715/501.1; 715/517; 715/513

(57) ABSTRACT

A user terminal for displaying a content includes a root meta information acquisition unit acquiring root meta information from among meta information for displaying one of a program and a content related to the program, a link meta information acquisition unit linking the root meta information to branch meta information under the layer of the root meta information, and acquiring link meta information containing link attribute indicating a common link, a template selecting unit selecting one template from among at least one template defining a layout position where the meta information is laid out in a display area of a display screen, and a layout unit selecting a layout rule, for laying out the meta information, in accordance with the selected template and laying out one of the root meta information and the link meta information in the display area.

### CROSS REFERENCES TO RELATED APPLICATIONS

The present invention contains subject matter related to Japanese Patent Application JP 2004-145357 filed in the Japanese Patent Office on May 14, 2004, the entire contents of which are incorporated herein by reference.

### BACKGROUND OF THE INVENTION

1. Field of the Invention

The present invention relates to a user terminal for displaying a content, a method for generating display data, and a computer program.

2. Description of the Related Art

Some known broadcasting stations provide viewers with a variety of contents including not only broadcast programs but also an electronic program guide (EPG) containing EPG information, and commodity catalog information in addition to broadcast programs, each related to the broadcast programs. Viewers are provided with services, such as an acquisition of a content related to a broadcast program and a purchase of commodities while viewing the program displayed on a display screen.

To produce program link information linking a content to a program, a program producer uses a program-linked data generator to add, to a program, contents such as a profile of a singer singing in a scene of a program, and detailed information concerning a commodity in a scene of the program. Such a technique is disclosed in Japanese Unexamined Patent Application Publication No. 2002-152694.

### SUMMARY OF THE INVENTION

To add a content, such as a profile of a singer, as additional information, a program needs to be linked beforehand. To this end, link information linking the program to the content is produced. Since the type of relation between linked pieces of information and the strength of the relation are not set, useful information customized and presented on a display screen has not been provided to users.

It is desirable to provide a user terminal, a display data production method, and a computer program for selecting information to be displayed on the display screen, and presenting information attractive to the users on the display screen in an efficient manner.

In accordance with one embodiment of the present invention, a user terminal for displaying a content includes a root meta information acquisition unit acquiring root meta information, belonging to a first layer, from among meta information for displaying one of a program and a content related to the program, a link meta information acquisition unit linking the root meta information to at least one piece of branch meta information under the layer of the root meta information, and acquiring link meta information containing link attribute indicating a common link from among other links, a template selecting unit selecting one template from among at least one template defining a layout position where the meta information is laid out in a display area of a display screen, and a layout unit selecting a layout rule, for laying out the meta information, in accordance with the selected template and laying out one of the root meta information and the link meta information in the display area of the template based on the layout rule and the link attribute.

When a user acquires the root meta information present in the first layer, the user may also acquire link meta information linked to the root meta information. The user lays out the branch meta information in the template in a manner to satisfy conditions provided by the layout rule and the link attributes contained in the acquired link meta information. The branch meta information having a link attribute satisfying the conditions written in the layout rule is laid out in the template. The user terminal thus provides, on a displays screen, information attractive to the user or information useful for increasing search efficiency.

Preferably, the layout unit lays out the link meta information and/or the branch meta information in the display area of the template in accordance with priority information contained in the root meta information and representing a priority according to which the meta information is laid out in the template. Information desired by a provider or user is displayed on the display screen with a higher priority. Useful information is thus efficiently supplied and used.

Preferably, the layout unit determines a total amount of branch meta information linked to the root meta information from the acquired link meta information and if the total amount of branch meta information is above a total amount of information displayable on the display screen, lays out, in the template, the branch meta information pointed by the link meta information, in the order from small to large amount of data, within a limit not exceeding the total amount of information displayable on the display screen. With this arrangement, the branch meta information is displayed on the display screen as much as possible. Useful information is displayed, efficiency of display data generation is heightened and the number of processes required for the display data generation is reduced.

Preferably, the layout unit determines a total amount of branch meta information linked to the root meta information from the acquired link meta information and if the total amount of branch meta information is above a total amount of information displayable on the display screen, lays out, in the template, the branch meta information pointed by the link meta information, in the order from high to low priority of data, within a limit not exceeding the total amount of information displayable on the display screen. This arrangement increases the possibility that information desired by the user is displayed on the display screen at a time regardless of a limited display screen area available.

Preferably, the link attribute contained in the link meta information includes at least one of a type of a link and a condition satisfying the link. The link attribute thus serves as a base for determination of whether to display the branch meta information on the display screen. Useful information is thus displayed on the display screen, and the user is able search target information.

The branch meta information is laid out in the template in accordance with the layout rule held in a shaping and converting rule engine.

The link meta information is reusable, and newly added root meta information may be linked to existing branch meta information belonging to a layer under the layer of the link meta information. Not only the newly added root meta information but existing root meta information may be linked to the existing branch meta information.

In accordance with one embodiment of the present invention, a user terminal for displaying a content, includes a root meta information acquisition unit acquiring root meta information, belonging to a first layer, from among meta information for displaying one of a program and a content related to the program, a template selecting unit selecting one template from among at least one template defining a layout position where the meta information is laid out in a display area of a display screen, and a layout unit selecting a layout rule, for laying out the meta information, in accordance with the selected template and laying out one of the root meta information and branch meta information in the display area of the template in accordance with the selected layout rule and common attribute information of common branch meta information from among at least one piece of branch meta information under the layer of the root meta information, the common attribute being generated according to attribute unit.

Preferably, the layout unit lays out one of the root meta information and the branch meta data in the display area of the template in accordance with priority information contained in the common attribute information and representing a priority according to which the meta information is laid out in the template.

Preferably, the layout unit determines a total amount of at least one piece of branch meta information, pointed by the common attribute information, on a per piece of common attribute information basis, the common attribute information contained in a single piece of root meta information, and if the total amount of branch meta information is above a total amount of information displayable on the display screen, lays out one of the root meta information and the branch meta information, in the order from high to low priority of data, within a limit not exceeding the total amount of information displayable on the display screen.

In accordance with one embodiment of the present invention, a method for generating display data on a user terminal displaying a content, includes steps of acquiring root meta information, belonging to a first layer, from among meta information for displaying one of a program and a content related to the program, linking the root meta information to at least one piece of branch meta information under the layer of the root meta information, acquiring link meta information containing link attribute indicating a common link from among other links, selecting one template from among at least one template defining a layout position where the meta information is laid out in a display area of a display screen, selecting a layout rule, for laying out the meta information, in accordance with the selected template, and laying out one of the root meta information and the link meta information in the display area of the template based on the layout rule and the link attribute.

The layout step preferably includes laying out the link meta information and/or the branch meta information in the display area of the template in accordance with priority information contained in the root meta information and representing a priority according to which the meta information is laid out in the template.

The layout step preferably includes determining a total amount of branch meta information linked to the root meta information from the acquired link meta information and if the total amount of branch meta information is above a total amount of information displayable on the display screen, laying out, in the template, the branch meta information pointed by the link meta information, in the order from small to large amount of data, within a limit not exceeding the total amount of information displayable on the display screen.

The layout step preferably includes determining a total amount of branch meta information linked to the root meta information from the acquired link meta information and if the total amount of branch meta information is above a total amount of information displayable on the display screen, laying out, in the template, the branch meta information pointed by the link meta information, in the order from high to low priority of data, within a limit not exceeding the total amount of information displayable on the display screen.

The link attribute contained in the link meta information preferably includes at least one of a type of a link and a condition satisfying the link.

In accordance with one embodiment of the present invention, a method for generating display data on a user terminal displaying a content, includes steps of acquiring root meta information, belonging to a first layer, from among meta information for displaying one of a program and a content related to the program, selecting one template from among at least one template defining a layout position where the meta information is laid out in a display area of a display screen, selecting a layout rule, for laying out the meta information, in accordance with the selected template, and laying out one of the root meta information and branch meta information in the display area of the template in accordance with the selected layout rule and common attribute information of common branch meta information from among at least one piece of branch meta information under the layer of the root meta information, the common attribute information being generated according to attribute unit.

The layout step may include laying out one of the root meta information and the branch meta data in the display area of the template in accordance with priority information contained in the common attribute information and representing a priority according to which the meta information is laid out in the template.

The layout step may include determining a total amount of at least one piece of branch meta information, pointed by the common attribute information, on a per piece of common attribute information basis, the common attribute information contained in a single piece of root meta information, and if the total amount of branch meta information is above a total amount of information displayable on the display screen, laying out one of the root meta information and the branch meta information, in the order from high to low priority of data, within a limit not exceeding the total amount of information displayable on the display screen.

In accordance with one embodiment of the present invention, a computer program for causing a user terminal to generate display data, includes steps of acquiring root meta information, belonging to a first layer, from among meta information for displaying one of a program and a content related to the program, linking the root meta information to at least one piece of branch meta information under the layer of the root meta information, acquiring link meta information containing link attribute indicating a common link from among other links, selecting one template from among at least one template defining a layout position where the meta information is laid out in a display area of a display screen, selecting a layout rule, for laying out the meta information, in accordance with the selected template, and laying out one of the root meta information and the link meta information in the display area of the template based on the layout rule and the link attribute.

In accordance with one embodiment of the present invention, a computer program for causing a user terminal to generate display data, includes steps of acquiring root meta information, belonging to a first layer, from among meta information for displaying one of a program and a content related to the program, selecting one template from among at least one template defining a layout position where the meta information is laid out in a display area of a display screen, selecting a layout rule, for laying out the meta information, in accordance with the selected template, and laying out one of the root meta information and the branch meta information in the display area of the template in accordance with the selected layout rule and common attribute information of common branch meta information from among at least one piece of branch meta information under the layer of the root meta information, the common attribute information being generated according to attribute unit.

In accordance with one embodiment of the present invention, a user terminal for generating display data includes a unit acquiring root meta information at a root position, from among meta information (portable information) for displaying at least one program and a content related to the program, a unit acquiring link meta information for linking the root meta information to at least a single piece of branch meta information under the layer of the root meta information for each link attribute, the link attribute representing relation between the root meta information and the branch meta information, a unit determining a total amount of information of the branch meta information that is linked to the root meta information based on the acquired link meta information, and a unit assigning the link attribute contained in the link meta information to the display area of the display screen instead of displaying the branch meta information under the layer of the root meta information, if the determined total amount of information is above a total amount of information displayable on a display screen.

In accordance with one embodiment of the present invention, the user terminal displays the link attribute contained in the link meta information, and an attribute value thereof together with the root meta information on the display screen instead of displaying the branch meta information if the total amount of information is above the total amount of information displayable on the display screen. With this arrangement, the information having almost the same amount of information as the information displayable on the display screen is presented to a user although the amount of information is limited.

When meta information is related to another piece of meta information, the link therebetween is established. Information displayed on the display screen is customized, and then efficiently displayed in a manner attractive to the user.

### BRIEF DESCRIPTION OF THE DRAWINGS

FIG. 1 is a block diagram diagrammatically illustrating an information providing system in accordance with one embodiment of the present invention;

FIG. 2 is a block diagram diagrammatically illustrating the information providing apparatus in accordance with the embodiment of the present invention;

FIG. 3 is a block diagram diagrammatically illustrating the information providing system in accordance with the embodiment of the present invention;

FIG. 4 is a block diagram diagrammatically illustrating a shaping and converting unit in accordance with the embodiment of the present invention;

FIG. 5 is a block diagram illustrating each module used in the information providing system in accordance with the embodiment of the present invention;

FIG. 6 illustrates the linking of link meta information in accordance with the embodiment of the present invention;

FIGS. 7B and 7B illustrate the linking of meta information in accordance with the embodiment of the present invention;

FIG. 8 illustrates an attribute of link and an attribute value in accordance with the embodiment of the present invention;

FIG. 9 illustrates a data structure with root meta information being program meta information in accordance with the embodiment of the present invention;

FIG. 10 illustrates a data structure of link meta information in accordance with the embodiment of the present invention;

FIG. 11 diagrammatically illustrates the linking of the meta information in accordance with the embodiment of the present invention;

FIG. 12 diagrammatically illustrates the linking of the meta information in accordance with the embodiment of the present invention;

FIG. 13 diagrammatically illustrates a display of the meta information presented on a display screen in accordance with the embodiment of the present invention;

FIGS. 14A and 14B diagrammatically illustrate a first modification of the display example of FIG. 13;

FIG. 15 diagrammatically illustrates a second modification of the display example of FIG. 13;

FIG. 16 diagrammatically illustrates the second modification of the display example of FIG. 13;

FIG. 17 diagrammatically illustrates a third modification of the display example of FIG. 13;

FIG. 18 diagrammatically illustrates a modification of the display example of FIG. 17;

FIG. 19 diagrammatically illustrates a fourth modification of the display example of FIG. 13;

FIG. 20 diagrammatically illustrates the fourth modification of the display example of FIG. 13;

FIG. 21 diagrammatically illustrates the fourth modification of the display example of FIG. 13;

FIG. 22 is a flowchart of a generation process of display data to be presented on a display screen in accordance with the embodiment of the present invention;

FIG. 23 is a continuation of the flowchart of FIG. 22; and FIG. 24 is a continuation of the flowchart of FIG. 23.

### DESCRIPTION OF THE PREFERRED EMBODIMENTS

The embodiments of the present invention are described below with reference to the drawings. In the discussion that follows, like reference numerals designate like elements.

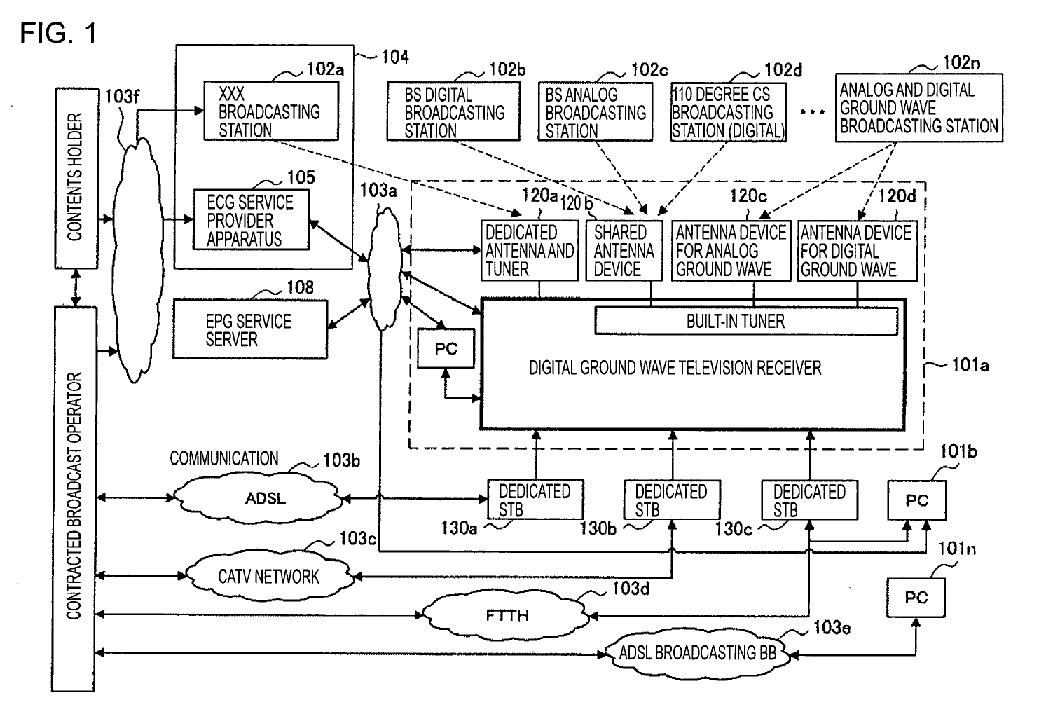

An information providing system 100 is described below with reference to FIG. 1. FIG. 1 is a block diagram illustrating the information provider apparatus 100 in accordance with one embodiment of the present invention.

As shown in FIG. 1, the information providing system 100 of the present embodiment includes a user terminal 101 (101a, 101b, . . . , 101n) on a viewer side, and a broadcasting station 102 (102a, 102b, . . . , 102n) as a provider, a network 103 (103a, 103b, 103c, 103d, 103e, and 103f), and a information provider apparatus 104. A broadcasting station 102a provides 124/128 degree communication satellite (CS) broadcast services and CS digital broadcast service, for example.

The information provider apparatus 104 of the present embodiment includes the broadcasting station 102a and the electronic content guide (ECG) service provider apparatus 105. The present invention is not limited to this arrangement. For example, at least one of the broadcasting stations 102b, 102c, 102d, . . . , 102n may include the ECG service provider apparatus 105 therewithin.

The ECG service provider apparatus 105 may be incorporated in each of the broadcasting stations 102 (102a, 102b, 102c, 102d, . . . , 102n) or may be incorporated in at least one of the broadcasting stations 102 (102a, 102b, 102c, 102d, . . . , 102n).

The broadcasting station 102 (contracted broadcasting operator) transmits programs to users by up-linking or down-linking broadcasting radiowaves. The broadcasting station 102 collects, from viewers, fees for transmitted programs.

The information providing system 100 of the present embodiment further includes at least one content holder, at least one contracted broadcasting operator, and at least one electronic program guide (EPG) service server 108.

The content holder produces, manages, and provides a variety of content bodies. The content holder also produces content meta information. The content bodies and the content meta information are supplied to the information provider apparatus 104.

The contracted broadcasting operator provides channels, and also produces programs, and organizes and outputs the programs. For example, the contracted broadcasting operator can be a program supplier.

In the information providing system 100 of the present embodiment, the ECG service provider apparatus 105 in the information provider apparatus 104 provides the user terminal 101 with program information in a program guide, such as an electronic program guide (EPG), electronic books, and contents such as videos.

The ECG service provider apparatus 105 of the present embodiment provides the program information contained in a broadcast program guide. The present invention is not limited to this arrangement. For example, a book list or a radio program guide may be also provided.

The EPG service server 108 also provides the EPG to the user terminal 101. The EPG service server 108 is different from the ECG service provider apparatus 105 in that the service of the EPG service server 108 is limited to the supplying of EPG program information to the user terminal 101.

The broadcast program guide includes at least one content. In the broadcast program guide, a content corresponds to a “program” containing program information. A plurality of programs form a broadcast program guide.

The user terminal 101 displays a broadcast program guide on the screen thereof. If program meta information of a program listed in the broadcast program guide is selected, the user terminal 101 searches a content related to the program meta information and acquires the content such as detailed information.

The user terminal 101 displays the acquired content in the display area of the display screen thereof. The content related to the program is located under the layer of the program meta information of the program listed in the broadcast program guide.

The EPG service server 108 of FIG. 1 receives organization information from each broadcasting station 102, and generates electronic program guide (EPG) information. The EPG service server 108 can acquire outsourced EPG information. The organization information is used to cause the programs to be in progress and to be broadcast as scheduled.

Basic EPG information is collectively delivered from the EPG service server 108 to the user terminal 101. Additional electronic content guide (ECG) information, as detailed information of the programs, such as the program meta information, and content meta information added to the content, can be managed by the broadcasting station 102 as a service provider. The program meta information and the content meta information contained in the ECG information will be discussed later. The broadcasting station 102 is not limited to the above-referenced arrangement, and may include any other apparatus depending on the service provided by the information provider apparatus 104.

The user terminal 101 includes an antenna section 120 (120a, 120b, 120c, and 120d) for receiving, from each broadcasting station 102, a broadcast wave bearing identification information containing meta information reference ID and meta reference information. As represented by arrow-headed broken lines shown in FIG. 1, the user terminal 101 receives the broadcast wave transmitted from the broadcasting station 102.

The user terminal 101 transmits data to and receive data from the information provider apparatus 104 via a network 103. Upon receiving the broadcast wave, the user terminal 101 displays programs including a television program.

The information providing system 100 of the present embodiment includes a single information provider apparatus 104. Alternatively, a plurality of information provider apparatuses 104 may be employed at each broadcasting station.

The information providing system 100 of the present embodiment may further include a payment mechanism device 116, such as an account aggregation server (not shown).

The payment mechanism device 116 authenticates a viewer (user) when the user uses the information providing system 100, performs a billing and payment process when the user purchases a content body using the information providing system 100, and performs a billing and payment process when a user on the producer side uses the information providing system 100. The payment mechanism device 116 collectively performs these processes independent of the program and the broadcasting station 102 broadcasting the program.

With the payment mechanism device 116, user authentication information is centralized so that unified authentication is performed. Similarly, billing and payment information is centralized on a per user basis. The centralization is performed on a group user ID that is an integration of a plurality of user IDs, and each user is authenticated using a single-sign-on method.

All services including the billing and payment process is integrated, and the payment mechanism device 116 as an agent performs an authentication process to permit access to all services in response to the group user ID. The payment mechanism device 116 can be constructed of a dedicated server, for example.

The access refers to information processing, performed through the network, including the utilization of the system, connection to the server, referencing files, storage of a file, deletion of a file, and modification of a file.

The structure of the information provider apparatus 104 of the present embodiment is described below. The content displayed on the user terminal 101 here is the program meta information contained in the EPG information.

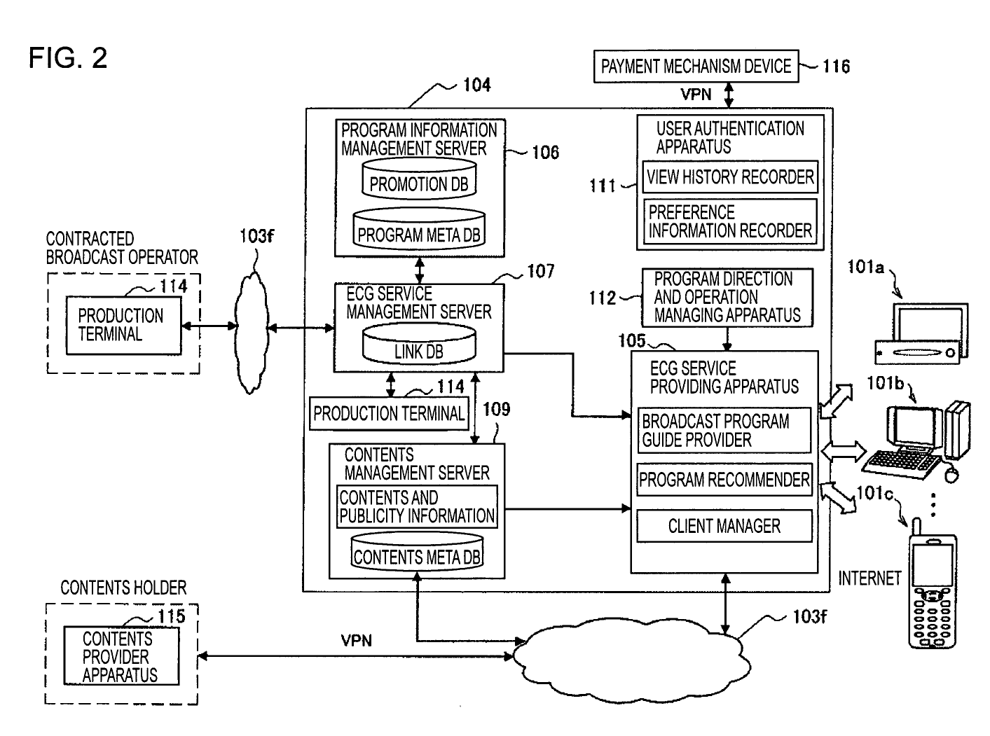

FIG. 2 is a block diagram illustrating the information provider apparatus 104 of the present embodiment. The information provider apparatus 104 is described below with reference to FIG. 2.

As shown in FIG. 2, the information provider apparatus 104 includes a program information management server 106 for managing information such as a program content, a ECG service management server 107 for linking program meta information of a program to content meta information of a content in order to provide the broadcast program guide composed of the ECG information, a contents management server 109 for managing a plurality of contents and content meta information, a user authentication apparatus 111 for authenticating a user on the producer side or the viewer side, an program direction and operation managing apparatus 112, and the ECG service provider apparatus 105. The ECG information will be described later.

A production terminal 114 is connected to the information provider apparatus 104 via a network 103f. For example, a program supplier corresponding to the contracted broadcasting operator is equipped with the production terminal 114. Alternatively, the production terminal 114 may be incorporated in the information provider apparatus 104.

The production terminal 114 supplies the ECG information, composed of a set of the program meta information and the content meta information, to the user terminal 101 by efficiently linking the program meta information stored in one of the program information management server 106 and the contents management server 109 to the content meta information.

A broadcast program guide service is to provide a broadcast program guide composed of one of the EPG information and the ECG information. The ECG information provides a variety of features not available from the EPG information as will be discussed later.

The broadcasting station 102 broadcasts a variety of programs to the user terminal 101 while transmitting the basic EPG information and the program meta information in data broadcasting service. Upon receiving the basic EPG information and the program meta information, the user terminal 101 displays one of EPG as the broadcast program guide and ECG.

The information provider apparatus 104 discussed here includes the broadcasting station 102. The present invention is not limited to this arrangement. For example, to transmit a “selling list of game playing software programs” and a “book catalog” instead of the EPG, the information provider apparatus 104 may include an ISP (Internet service provider) or a selling apparatus (not shown) for selling the game playing software programs.

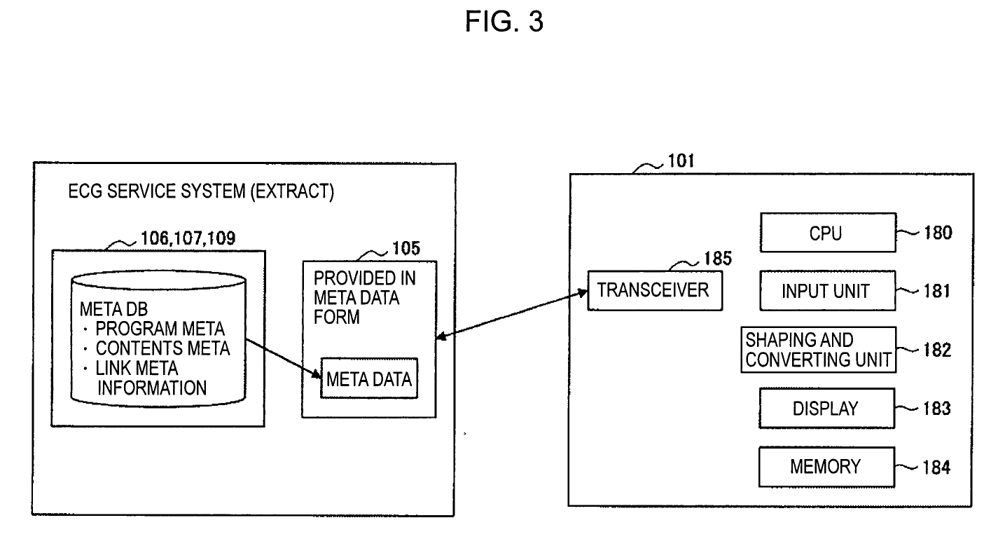

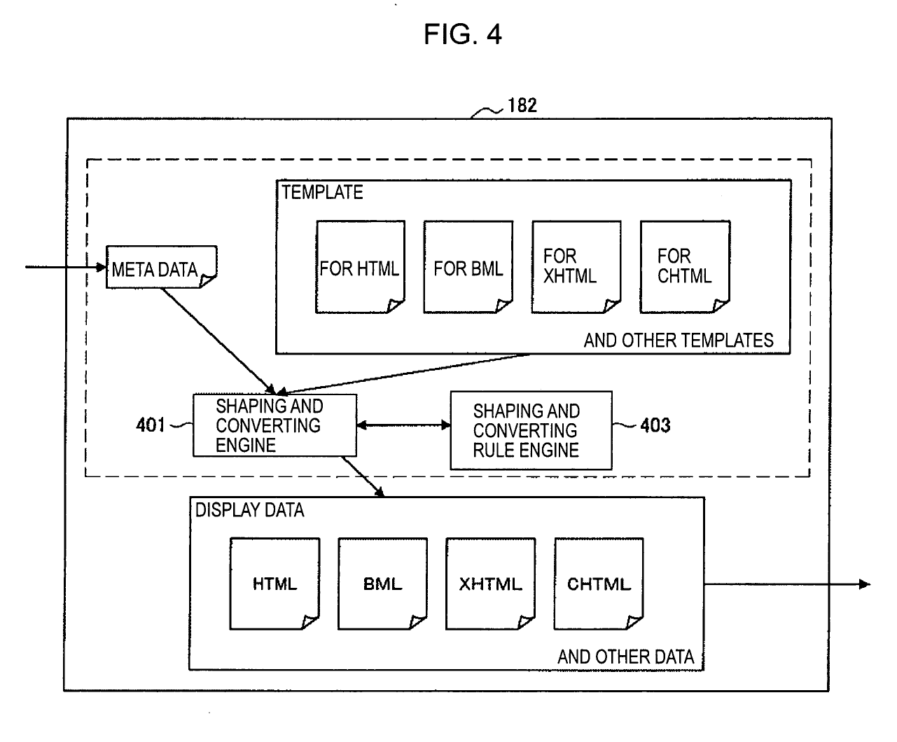

Referring to FIGS. 1-4, the structure of the information providing system 100 of the present embodiment is described below. FIG. 3 is a block diagram of the information providing system 100, and FIG. 4 is a block diagram of a shaping and converting unit of the user terminal 101.

As shown in FIG. 1, the network 103 of the present embodiment is described below. A network 103a and a network 103f establish two-way communications between the information provider apparatus 104 and the user terminal 101. The network 103a and the network 103f are typically the internet to which the information provider apparatus 104 and the user terminal 101 are connected via an asymmetric digital subscriber line (ADSL), a fiber to the home (FTTH), or a cable television network. Connection medium may be wireless or wired. For example, the connection medium may be an optical cable through a fiber distributed data interface (FDDI), coaxial cable or twist-pair cable of Ethernet®, radio communication of IEEE802.11b, or a communication satellite.

A network 103b of the present embodiment establishes two-way communications between the contracted broadcast operator and a dedicated set top box (STB) 130a. The network 103b is typically an ADSL or a similar one. A network 103d and a network 103e are networks similar to those discussed above.

A network 103c of the present embodiment establishes two-way communications between the contracted broadcast operator and a dedicated set top box (STB) 130b. The network 103c is typically a CATV or a similar network. A network 103d and a network 103e are networks similar to those discussed above.

As shown in FIG. 2, the program information management server 106 is a computer including at least a central processing unit (CPU), an input unit, and a display. The program information management server 106 further includes a program meta DB (database) for storing a plurality of pieces of program meta information and a promotion DB storing promotion information.

The program meta information is produced when program information containing a title of a program, organization of the program, and a sponsor name is produced. The promotion information is needed when the program is advertised.

The program meta information is produced by a program meta producing apparatus (not shown) connected to the program information management server 106. The contracted broadcast operator may be equipped with the program meta producing apparatus, and the program meta information produced by the program meta producing apparatus may be transmitted to the program information management server 106 via the network.

The ECG service management server 107 is a computer including at least a CPU, an input unit, and a display. The ECG service management server 107 further includes a link meta DB storing a plurality of pieces of link meta information. The ECG service management server 107 also performs an authentication process when the production terminal 114 accesses the ECG service management server 107. The production terminal 114 will be discussed further later.

The link meta information is generated by the production terminal 114. The production terminal 114 transmits the generated link meta information to the ECG service management server 107 via the network 103. The production terminal 114 may be incorporated in the information provider apparatus 104 in a manner such that the production terminal 114 is connected to the ECG service management server 107. The link meta information is used to link the program meta information to the content meta information. The link meta information will be discussed further later.

The contents management server 109 is a computer including at least a CPU, an input unit, and a display. The contents management server 109 further includes a content meta DB storing a plurality of pieces of content information. A plurality of content meta DBs may be arranged by category, for example, one content meta DB for publication, one content meta DB for movie, and so on. Alternatively, a single centralized content meta DB may be used regardless of category.

The content meta information is produced by a content meta data producing apparatus connected to the contents management server 109. A contents provider apparatus 115 of a contents holder or a publicity agent may produce the content meta information, and may transmit the produced content meta information to the contents management server 109. The contents provider apparatus 115 may transmit the content meta information in a format of broadcast markup language (BML), a hyper-text markup language (HTML), or a compact-hyper-text markup language (C-HTML) to the ECG service provider apparatus 105 via the network 103.

The user authentication apparatus 111 is a computer including, at least, a CPU, an input unit, and a display. A view history recorder or a preference information recorder in the user authentication apparatus 111 manages history information of programs viewed by a viewer who uses the user terminal 101 and preference information of the viewer, respectively. If a request to purchase a content is issued from the user terminal 101, the user authentication apparatus 111 requests the payment mechanism device 116 to perform a payment process.

The program direction and operation management apparatus 112 is a computer including, at least, a CPU, an input unit, and a display. The program direction and operation management apparatus 112 transmits, to the ECG service provider apparatus 105, information relating to the broadcast program guide composed of a plurality of pieces of the ECG information and control information for supplying data.

The ECG service provider apparatus 105 is a computer including, at least, a CPU, an input unit, a memory, a display, a transmitter for transmitting data to the user terminal 101 using via the network 103 or a broadcast wave, and a receiver for receiving data from the user terminal 101. The ECG service provider apparatus 105 includes a broadcast program guide provider for providing a broadcast program guide, a program recommender, and a client manager for managing clients and execution of campaigns.

The ECG service provider apparatus 105 stores, by layer, a broadcast program guide or detailed information, which the contents provider such as a broadcasting station provides to the viewer. As necessary, the detailed information may contain information for purchasing a commodity, a location of the detailed information, and how to acquire the detailed information.

Memories in the ECG service provider apparatus 105 store the content meta information. The content meta information is linked to the program meta information. For example, branch information originated from the program meta information is the content meta information. The content meta information may include story information of a preceding program, information about performers of the program, information about books relating to the program, music information relating to the program, etc.

The memories store, as the detailed information, book information relating to a program of a main content, and web site information relating to a site selling commodities such as CDs. The memories store web site information relating to the program.

The contents of the present embodiments are stored in the memories in the ECG service provider apparatus 105 in the broadcasting station. Furthermore, the contents may be stored in a memory in a ECG service provider apparatus 105 on another network 103. The content meta information supplied as the ECG information may be added to the contents as a subcontent.

The meta information, such as the program meta information and the content meta information, from the ECG service provider apparatus 105 is transmitted to the user terminal 101 via the network 103, and is converted on the user side into data to be displayed on a display screen in accordance with a template such as BML.

The information providing system 100 of the present embodiment includes a plurality of broadcasting stations 102. A single information provider apparatus 104 may be shared by a plurality of broadcasting stations 102.

The user terminal 101 of the present embodiment is described below with reference to FIG. 1. The user terminal 101 (101a, 101b, . . . , 101h) may be one of consumer electronics including a digital television set, a cellular phone, a personal computer (PC), a game playing machine and a car navigation system. The PC of the present embodiment is not limited to any particular computer. For example, the PC may be any of a workstation, and mobile terminals including a personal digital assistant (PDA).

As shown in FIG. 1, an antenna section 120 in the user terminal 101a receives the broadcast wave bearing one of the basic EPG information and the program meta information. A receiver (not shown) in the user terminal 101a receives the basic EPG information via the network 103.

The user terminal 101 of the present embodiment receives data from the broadcasting station 102. The present invention is not limited to this arrangement. The user terminal 101 may receive, from an ISP other than the broadcasting station 102, the basic EPG information, the program meta information, and the meta information reference ID (meta reference information).

As shown in FIG. 3, the user terminal 101 includes a CPU 180, an input unit 181, a shaping and converting unit 182, a display 183, a memory 184, and a transceiver 185.

The memory 184, storing a variety of software programs, may be a hard disk drive. Alternatively, the memory 184 may be one of a read-only memory (ROM), a dynamic random-access memory (DRAM), and an electrically erasable programmable read-only memory (EEPROM). The memory 184 may be composed of a plurality of units. The memory 184 may be external to the user terminal 101.

The input unit 181 includes, but is not limited to, a keyboard and a pointing device for receiving an operational input from a user, such as a mouse, a trackball, a track pad, a stylus pen, or a joystick.

The display 183 displays published matter, contents such as movies, text of a broadcast program guide, moving images, and still images, and further outputs a sound signal.

The transceiver 185 receives location information such as a uniform resource identifier (URI) of the program information management server 106 via the network 103, and then stores the URI in the built-in tuner thereof. The location information such as the URI may be input through the input unit of the user terminal 101 and then stored. The user terminal 101 gains access to the information provider apparatus 104 by means of the URI.

The user terminal 101 may be connected to the network 103 using a dial-up connection or ADSL/FTTH connection.

The user terminal 101 receives, via the broadcast wave or the network 103, one of the basic EPG information and the program meta information while receiving the meta information reference ID attached to each program at the same time. The meta information reference ID is an identifier identifying the meta information such as the content meta information. Using the identifier, the user terminal 101 receives the content meta information. In addition to the meta information reference ID, link information such as URI information identifying the location of the content meta information may be described beforehand in one of the program meta information and the link meta information. Information containing the meta information reference ID may also referred to as meta reference information.

The transceiver 185 receives, via service information (SI) by the broadcast wave or via the network 103, the basic EPG information with the meta information reference ID attached thereto and the program meta information, and displays the received information on the display screen.

When the meta information reference ID is acquired via SI, the user terminal 101 identifies the broadcasting station based on broadcast station information. For example, according to broadcast standard standardized by the association of radio industries and businesses (ARIB), SI contains a service ID identifying a broadcasting station. The broadcast station information containing the service ID is linked to the meta information reference ID.

The user terminal 101a includes a digital television, a personal computer (PC), an antenna section 120, a dedicated set top box (STB) 130 (130a, 130b, and 130c).

The digital television unit includes built-in tuners for an antenna device 120b, an antenna device 120c, and an antenna device 120d. The digital television unit also includes a hard disk drive (not shown) for recording the broadcast program guide such as EPG and ECG transmitted from the EPG service server 108 and the information provider apparatus 104.

The dedicated STB 130 receives a variety of programs, provided by the contacted broadcast operator, via a broadband network 103. The user terminal 101 can thus display the program without the need for the use of the broadcast wave.

The user terminal 101a of the present embodiment includes the digital television unit and the PC. The present invention is not limited to this arrangement. For example, the user terminal 101a may include only a digital television unit.

If the program meta information stored in one of the program information management server 106, the ECG service management server 107, and the contents management server 109 is transferred to the ECG service provider apparatus 105 as shown in FIG. 3, the program meta information is transmitted to the user terminal 101 as is via the network 103.

The user terminal 101, including the CPU 180, converts the data coming in from the ECG service provider apparatus 105 into data displayable on the display 183 using the shaping and converting unit 182.

The shaping and converting unit 182 adds information relating the display screen of the terminal to the received meta information and then converts the meta information into data in one of BML, HTML, C-HTML formats. The present invention is not limited to this arrangement. Any particular display format or a mere list display is perfectly acceptable.

The shaping and converting unit 182 of the present embodiment described below with reference to FIG. 4. FIG. 4 is a block diagram diagrammatically illustrating the shaping and converting unit 182.

When the shaping and converting unit 182 receives the meta information (meta data) such as the program meta information, a shaping and converting engine 401 lays out the meta information in a display area of a template corresponding to a display area of a display screen. The shaping and converting engine 401 thus generates and/or modifies the layout of the screen for displaying the meta information.

Upon receiving the meta data, the shaping and converting engine 401 analyzes the meta data, determines a template matching the meta data, and stores the template onto the memory 184. A predetermined template may be determined at the reception of the meta data.

The shaping and converting engine 401 determines a layout destination of the meta data in accordance with a shaping and converting rule (linking rule and layout rule) managed by the shaping and converting rule engine 403. For example, the linking rule requires that meta data other than that having the highest priority be not laid out in the display area of the template, if the template is a BML template, if display data contained in the meta data is above 500×500 pixels, or if the meta data is above 500 characters.

When the shaping and converting engine 401 lays out the meta data and an entire layout is completed, the display 183 displays template data with the meta data laid out in one of the HTML, BML, XHTML, and CHTML formats as the display data.

The shaping and converting engine 401 is stored in the memory 184, such as a hard disk. The shaping and converting engine 401 may be a software program composed of at least one program module. The shaping and converting engine 401 may be Applet, which is a program module requiring no installation.

A variety of data and data structures thereof for use in the information providing system 100 of the present embodiment are described below.

A content meta producing apparatus (not shown) produces the content meta information. The content meta information is attached to the body of a content or organization information. The content meta information is used to attach a link to the program meta information of a program as a main content. The body of the content includes at least one of a commercial commodity, a software program, a package, a service, still image data, moving image data, music data, and a text, with the content meta information thereof having a link, and is supplied by the ECG service provider apparatus 105.

The content is not only supplied by the ECG service provider apparatus 105, but also by a content server (not shown), as a computer managing contents, connected via the network 103.

The content meta information is located under the program meta information of a plurality of programs (main contents) contained in the broadcast program guide. By accessing the program meta information, the user terminal 101 can automatically access the content meta information related to the program meta information.

The user thus gains access to the content meta information, such as the detailed information of the program, via the program meta information, and then to a substance (such as a commodity) of a target content. The user can thus purchase the commodity by performing the billing and payment process.

The program meta producing apparatus generates the program meta information and attaches the generated program meta information to the organization information. The program meta information attached to the organization information is organized as one of the basic EPG information and the ECG information to be delivered to the user terminal 101. The basic EPG information is information organized in the EPG form. The program meta information and the content meta information are information representing another piece of information. The program meta information will be described later.

The basic EPG information contains the program meta information, and contains structure information as a program guide. The basic EPG information is transmitted in the HTML format via the network 103. If the broadcast wave is used, the basic EPG information is transmitted in the SI format.

The user terminal 101 acquires the program meta information, and reads the link reference information (link meta information identifier) and content meta reference information (content meta information identifier) described in the program meta information. The user terminal 101 can thus gain access to the link meta information and the content meta information at a link destination. The content meta information and the program meta information belong to the ECG information. The ECG information will be discussed later. The link meta reference information and the content meta reference information are also collectively referred to as meta reference information (common attribute information).

The user terminal 101 can acquire the broadcasting station information identifying the broadcasting station 102 and contained in one of the program meta information and the basic EPG information via the network 103.

The ECG information is described below. The ECG information includes the program meta information and the content meta information.

With the ECG information, the user terminal 101 extends the basic EPG (electronic program guide) information as data for searching TV programs, searches not only the TV program but also a variety of contents on the Internet, and acquires necessary information. Part of the ECG information corresponds to the basic EPG information.

With the ECG information, namely an extension of the EPG information, the target to be searched for is not limited to the television program. The user can search the detailed information and a variety of commodities via the network 103. The user then acquires the found detailed information and commodities.

From among the meta information supplied as the ECG information, the program meta information is meta information attached to the broadcast program guide. A plurality of programs contained in the broadcast program guide are contents which are supplied by the information provider apparatus 104 as main contents.

If the information provider apparatus 104 is equipped with the broadcasting station 102, the main contents include broadcast programs, the EPG information, and the organization information. If the information provider apparatus 104 is equipped with a DVD (digital versatile disk) selling apparatus instead of the broadcasting station 102, the main contents are a DVD selling list, and the commodities are DVD software programs.

If the main content is the EPG information or the organization information, main meta information of the present embodiment is the “program meta information”. The program meta information (a title of a program, jenre, category, performers, etc.) can be delivered via the SI (service information) on the broadcast wave and via a EPG service (the service content thereof partially different from service to service) over the Internet.

When a variety of meta information including the program meta information and the content meta information is displayed on the display area of the display screen of a display 183, the meta information corresponds to the content information. For example, the program meta information, such as the title of the program, broadcast time, and performer names, corresponds to the content information.

From among the meta information supplied as the ECG information, the content meta information is attached to the substance of the content. The substance (commodity) of the content is linked to the content meta information, such as at least one piece of detailed information linked to the program meta information. The user acquires the substance by referencing the content meta information.

From among the meta information supplied as the ECG information, the program meta information is related to the program. The program meta information contains a name of a program, genre, performer's names, etc.

The program meta information is delivered in the SI via the broadcast wave or from the EPG service server 108 (the service content thereof partially different from service to service) via the Internet. The program meta information contained in the ECG information is different in data structure from the basic EPG information. Even if the program meta information is expressed as the basic EPG information, the content of the program meta information remains identical to the basic EPG information.

The content meta information is contained in the ECG information. The production terminal 114 links the content meta information to the program meta information, thereby producing the link meta information. The ECG service management server 107 stores the link meta information.

The content meta information may contain location information (site information) of a content as a URI, the name of the content, a name of a person, such as an author's name, a name of a producer of the content, and a service availability period of the content. A uniform resource locator (URL) is contained in the system of URI.

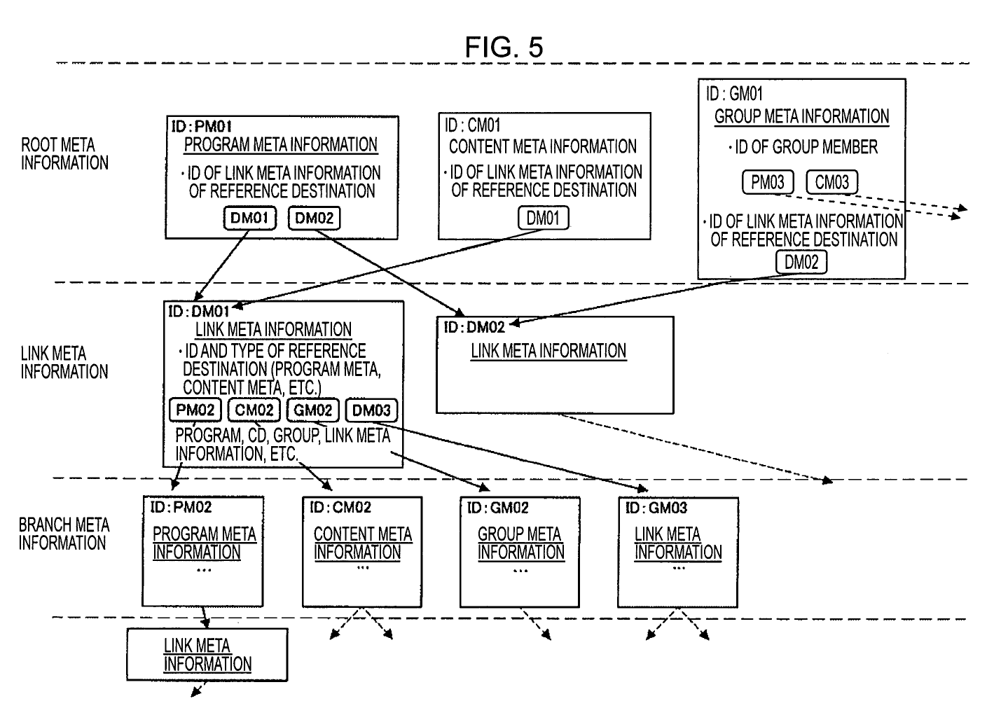

A link structure of the meta information of the present embodiment is described below with reference to FIG. 5. FIG. 5 diagrammatically illustrates the link structure of the meta information of the embodiment of the present invention.

As shown in FIG. 5, the meta information of the present embodiment has a data structure composed of a plurality of layers where at least one piece of meta information is linked. Arranged in a first layer as a root (root meta information) are program meta information (ID: PM01), content meta information (ID: CM01), and group meta information (ID; GM01). The group meta information contains a group of meta information having a common attribute and attribute value.

The program meta information belonging to the ECG information includes program-related attributes, such as “a name of a program”, “program category”, “broadcast time”, and “rebroadcasting”, performer-related attributes, such as “names and abbreviated names of performers”, “category of performers”, “name of talent pool”, and control-related attributes, such as a “meta information version” indicating a version of the program meta information, “updating status” indicating the possibility of updating of a plurality of meta information groups present under the lower layer, and “update timing” indicating a timing of updating of the meta information groups.

The content meta information includes music-related attributes, such as a “name of music”, a “name of a musician”, a “name of a record company”, and a “music purchasing site URL”, shop-related attributes, such as a “name of a store”, and a “location of the store”, commodity-related attributes, such as a “name of a commodity”, and a “commodity purchasing site URL”, promotion-related attributes, such as a “site of a URL for inviting users to access thereto”, and control-related attributes, such as a “meta information version” indicating a version of the program meta information, “updating status” indicating the possibility of updating of a plurality of meta information groups present under the lower layer, and “update timing” indicating a timing of updating of the meta information groups.

The link meta information ID identifying the link meta information is also described in the program meta information. As shown in FIG. 5, for example, the link meta information ID “DM01” and “DM02” are described in the program meta information as the root meta information.

If the link meta information ID to be referenced is descried in each meta information, any link meta information can be referenced regardless of whether the meta information is the program meta information or the content meta information.

The link meta information is present under the layer of the root meta information. The link meta information links the root meta information to the branch meta information under the layer of the link meta information. In a linking operation, a variety of link attributes are set.

If at least one piece of meta information is present, meta information in a (second) layer below the first layer is referred to as branch meta information, and meta information in the first layer is referred to as the root meta information. In other words, the branch meta information is present under in a layer below the layer of the root meta information. The meta information contains the program meta information, the content meta information, and the link meta information.

The link meta information contains attributes, such as a meta information ID and the type of a reference destination in the layer under the link meta information. The user terminal 101 can efficiently determine the type of the meta information of the reference destination of the link meta information (such as a program or music). The meta information such as any program meta information and any content meta information may be linked in a layer below the layer of the link meta information.

FIG. 5 illustrates the meta information organized in three layers. The present invention is not limited to this arrangement. The meta information may be arranged in a single layer, two layers, or more layers. The branch meta information is linked by the link meta information thereabove, and is not root meta information. But with the branch meta information linked to meta information by the link meta information, the branch meta information becomes root meta information.

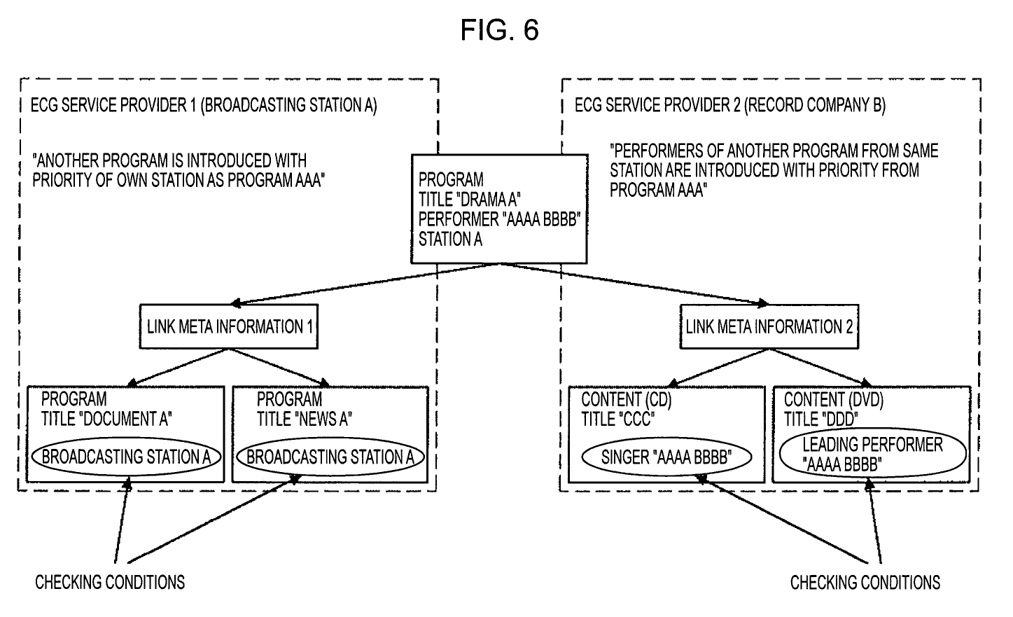

A specific usage example of the link meta information of the present embodiment is described below with reference to FIG. 6. FIG. 6 diagrammatically illustrates the linking process of the link meta information of the present embodiment.

As shown in FIG. 6, each of a broadcasting station A and a record company B provides respective ECG information to viewers. If the same program is present in the supplied ECG information, the two entities share a single piece of meta information, and the meta information is efficiently produced.

Search efficiency of the meta information is enhanced by dividing the link meta information by provider for example into link meta information 1 linking content meta information in a layer under the content meta information related to the broadcasting station A, and link meta information 2 linking content meta information in a layer under the content meta information related to the record company B.

As shown in FIG. 6, the record company B may wish to provide the meta information about performers on the program with a priority placed on another program in the broadcasting station A. If identification (ID) information of the meta information satisfying the above condition is described in the link meta information 2, the meta information in the layer below the link meta information is efficiently searched for.

The broadcasting station A and the record company B provide different related contents. However, if the link meta information is not managed on a per provider basis, direct searching from the program meta information cannot be performed according to the type of provider, such as the broadcasting station A and the record company B.

All content meta information in a layer below the link meta information of FIG. 6 needs to be read, and an attribute value of an attribute corresponding to “checking conditions” needs to be verified. Such an operation leads to a low search efficiency.

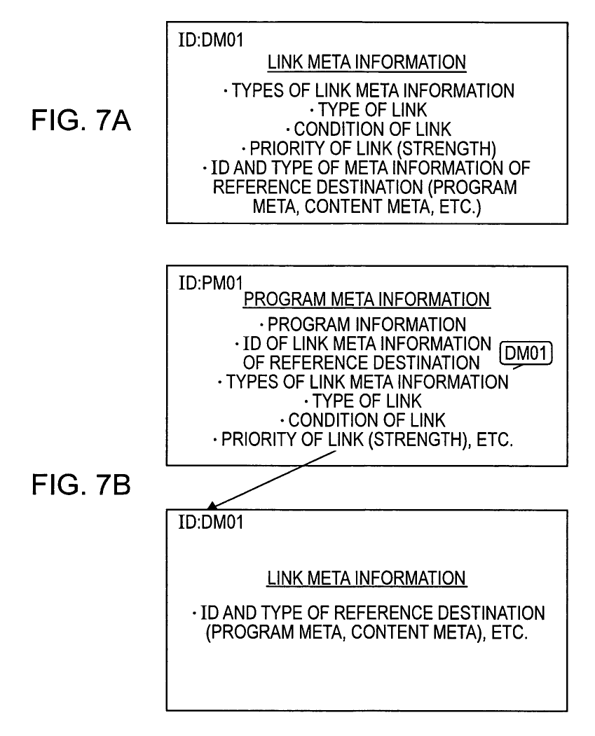

The linking operation of the meta information of the present embodiment is described below with reference to FIGS. 7A and 7B.

As shown in FIGS. 7A and 7B, the meta information is divided into two class. As shown in FIG. 7A, a first class has a data structure including an attribute related to linking to all the link meta information and an attribute value.

In the link meta information shown in FIG. 7A, the program meta information and the content meta information are the root meta information, and the link meta information is linked to a layer below the root meta information. The attribute value of the linking is summarized in the link meta information.

As shown in FIG. 7A, the link meta information includes attributes, such as the type of the link meta information, the type of link, the condition of link, the priority of link (strength), the ID and the type of the meta information of a reference destination. The condition of link may include a factor other than time.

As shown in FIG. 7B, a second class has a data structure that distributes an attribute related to a link between the root meta information of one of the content meta information and the program meta information, and a distributed attribute value.

As shown in FIG. 7B, the program meta information as the root meta information includes attributes such as the type of the link meta information, the type of link, the condition of link, the priority of link (strength), the ID and the type of the meta information of a reference destination.

The ID of the meta information of the reference destination linked in a layer under the link meta information and the attribute of type of the meta information are described in the link meta information. The number of attributes described in the link meta information of FIG. 7B is smaller than the number of attributes described in the link meta information of FIG. 7A. Since a major portion of the attribute information related to the linking of the meta information is described in the root meta information of FIG. 7B. If the link meta information corresponding to the root meta information is searched, the link meta information is efficiently reused without the need for customizing.

Since the meta information is linked in accordance with the supplying manner of the ECG information, the meta information such as target content meta information can be searched for through the root meta information, and the meta information is efficiently provided.

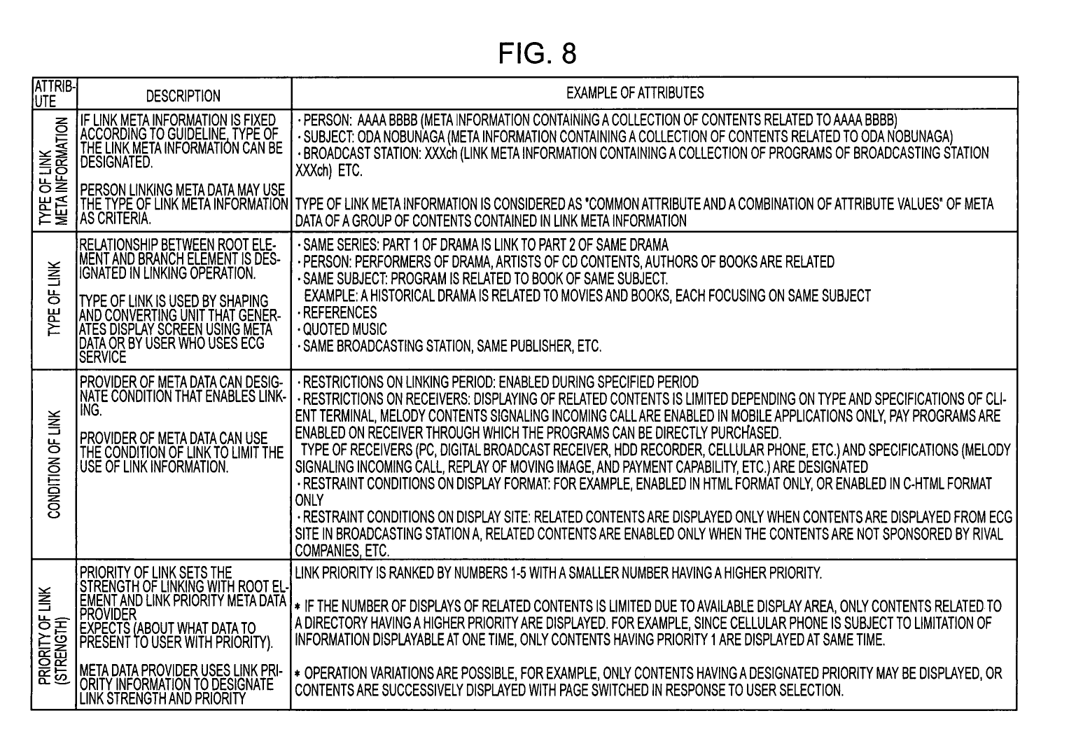

The link attribute of the meta information of the present embodiment is described below with reference to FIG. 8. FIG. 8 illustrates the link attribute and the attribute value in accordance with the embodiment of the present invention.

As shown in FIG. 8, the link attributes of the present embodiment include the type of the link meta information, the type of link, the condition of link, and the priority of link. The present invention is not limited to these link attributes. Any other link attribute may be added.

The type of the link meta information of FIG. 8 is an attribute such as a subject common to all the root meta information and the branch meta information. For example, the meta information is produced, and a criterion is fixed in the linking operation. The criterion may be set as the type of the link meta information.

An attribute positioned as a higher concept common to all of persons, broadcasting stations, and sporting programs may be introduced as a type of the link meta information. The attribute value of the type may be “AAAA BBBB” as a person, and “XXXch” as a broadcasting station, for example.

The type of link attribute refers to the relation of the link of the root meta information and the branch meta information. As shown in FIG. 8, the type of link attribute may be “the same series” representing a series of programs including a prequel and a quell, and “references”.

The condition of link attribute represents a valid/invalid status of the linking of the link meta information linking the root meta information to the branch meta information. With the condition of link attribute, access to the branch meta information is permitted only when the condition is satisfied.

The condition of link of FIG. 8 may include a link availability period throughout which the linking is effective, a receiver representing the user terminal 101 that validates the linking, a display format validating the link, and a display location validating the linking.

The priority of link is an attribute representing the priority or strength of link of the root meta information linked to the branch meta information by the link meta information linking. With this attribute, the meta information is displayed in the order of high to low priority within a limited display screen area. The attribute value of the priority of link may be numeric designations from 1 through 5 (with a smaller number designating a higher priority).

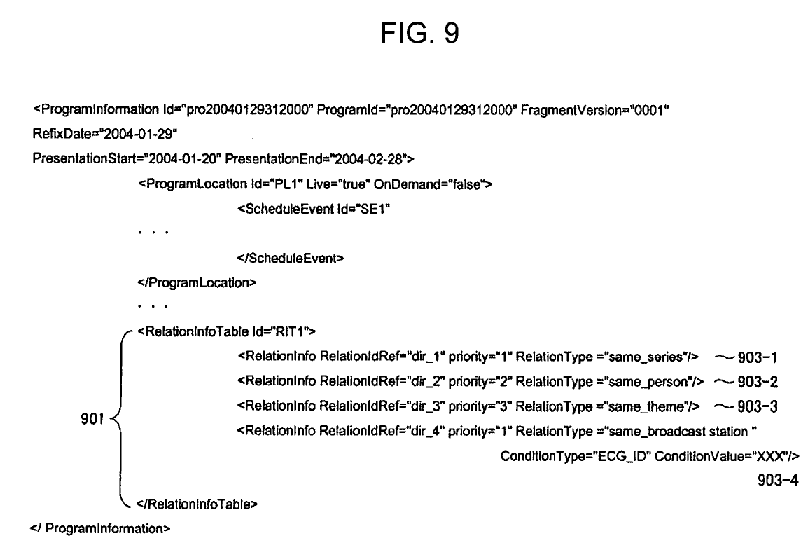

The data structure of the root meta information is described below with reference to FIG. 9. FIG. 9 diagrammatically illustrates the data structure of the program meta information as the root meta information.

The root meta information contains an identifier identifying the root meta information and an identifier identifying the link meta information of a reference (link) destination. The identifiers identifying the link meta information are tabled.

As shown in FIG. 9, the identifier identifying the link meta information is registered in table 901 (<RelationInfoTable Id=“RITI”>through </RelationInfoTable>) of table ID “RITI” in the program meta information as the root meta information.

Meta reference information 903 (903-1, 903-2, 903-3, and 903-4) for accessing at least one piece of program meta information and the link meta information is registered in the table 901 of RITI. The meta reference information 903 contains at least one identifier of meta information of the reference destination (“dir_1” through “dir_4”), attributes and attribute values.

The attributes and the attributes values of the meta reference information 903 include the attribute “priority”, the attribute “RelationType” (type of link), the attribute “ConditionType) (the condition of link), and the attribute “ConditionValue” (value of link). Any attribute and/or an attribute value may be added to and/or deleted from the meta reference information 903.

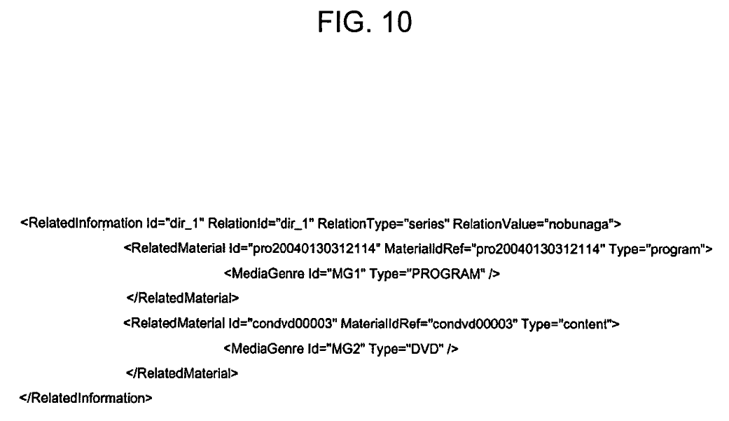

In accordance with the present embodiment, the attribute values of FIGS. 9 and 10 are ones described in succession to a symbol “=”. In the case of ‘priority=“1”’, “1” following the symbol “=” is an attribute value. More specifically, the attribute “priority” is 1.

The data structure of the program meta information as the root meta information of FIG. 9 has been discussed. The data structure of the content meta information as the root meta information is substantially the same.

The present invention is not limited to tags, attributes, and attributes value defined in the root meta information of FIG. 9. Any tag, attribute, and attribute value may be used as long as the same function is performed.

The data structure of the content meta information is described below with reference to FIG. 10. FIG. 10 illustrates the data structure of the link meta information.

The link meta information includes an identifier identifying the attribute, the attribute value, and the link meta information, and an identifier identifying the branch meta information in a layer under the link meta information as the reference destination (link destination).

The identifier identifying the link meta information is described as “dir_1” at “RelationID” in the link meta information as shown in FIG. 10. Furthermore, an attribute “RelationType” (type of link) and an attribute “RelationValue” (value of the type of link) are described as the attribute and the attribute value of the link meta information. Any attribute and/or an attribute value may be added to and/or deleted from the link meta information of the present invention.

As shown in FIG. 10, the attribute “RelationType” is “series” meaning a series of drama, and the attribute “RelationValue” is “nobunaga” meaning a drama called “Nobunaga”.

Furthermore, an identifier identifying the branch meta information in a layer under the link meta information is defined by “MaterialIDRef”, followed by “pro20040130312114”.

The present invention is not limited to tags, attributes, and attributes value defined in the root meta information of FIG. 10. Any tag, attribute, and attribute value may be used as long as the same function is performed.

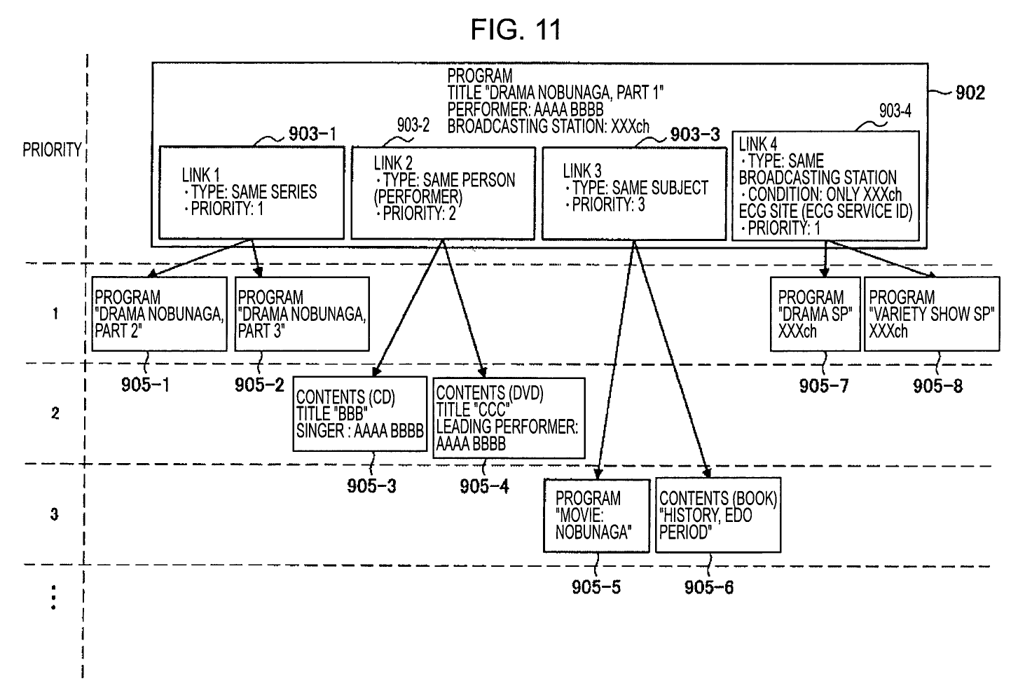

The link between the root meta information and the branch meta information in accordance with the present invention is described below with reference to FIG. 11. FIG. 11 diagrammatically illustrates the link of the meta information of the present embodiment.

As shown in FIG. 11, the program meta information as root meta information 902 (program, title “drama Nobunaga”, part 1, performer; AAAA BBBB, and broadcasting station: XXXch”) is present at a top layer. A plurality of pieces of branch meta information 905 related to the program is linked to a layer under the program meta information.

No link meta information is present in the link of the meta information as shown in FIG. 11, and the program meta information as the root meta information 902 is directly linked to one of the program meta information and the content meta information. The branch meta information 905 of FIG. 11 is arranged at layers prioritized with 1, 2, 3, . . . in vertical direction.

The program meta information as the root meta information 902 includes the meta reference information 903 for referencing the meta information such as the content meta information, and the link meta information. As shown in FIG. 11, the program meta information includes meta reference information 903-1, meta reference information 903-2, meta reference information 903-3, and meta reference information 903-4.

Since the attribute value of the priority of the meta reference information 903-1 is “1”, branch meta information (content meta information) 905-1 and branch meta information (content meta information) 905-2, as the reference destinations of the meta reference information 903-1 has the highest priority.

The user terminal 101 references the meta reference information 903 by accessing the program meta information as the root meta information 902. The user terminal 101 thus learns the branch meta information 905 present in a layer under the root meta information 902 by referencing the attribute and/or the attribute value, such as the type and priority of the meta information of the reference destination.

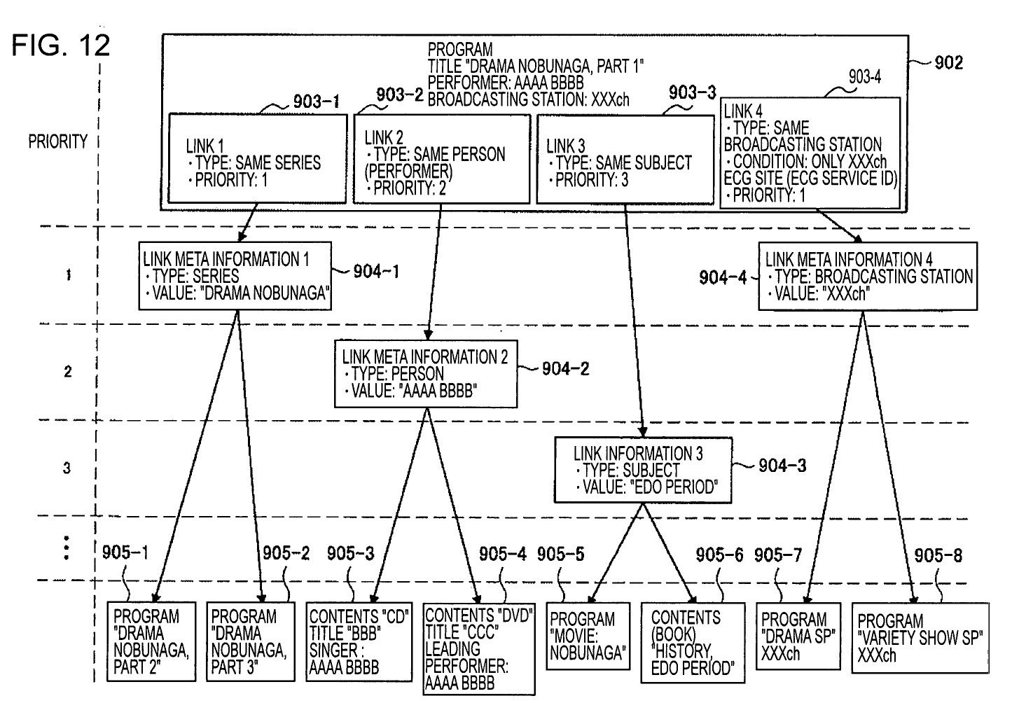

The linking of the root meta information to the branch meta information is described below with reference to FIG. 12. FIG. 12 diagrammatically illustrates the link structure of the meta information.

Referring to FIG. 12, the program meta information 902 is present as the root meta information at the top layer. At least one piece of link meta information is linked at the layer under the program meta information 902. Furthermore, branch meta information is present in the layer under that link meta information.

The link structure of the meta information of FIG. 12 is different from the link structure of the meta information of FIG. 11. As shown in FIG. 12, the root meta information 902 is linked to each branch meta information 905 via link meta information 904 (904-1, 904-2, 904-3, and 904-4). The link meta information 904 is linked at layers prioritized with 1, 2, 3, . . . in vertical direction.

The root meta information 902 includes the above-referenced meta reference information 903. Since the attribute value of the priority of the meta reference information 903-1 is “1”, the priority of the link meta information 904-1 as the reference destination of the meta reference information 903-1 is the highest. The priority of the branch meta information 905-1 and 905-2, linked to the link meta information 904-1, is also “1”.

The user terminal 101 references the meta reference information 903 by accessing the root meta information 902. The user terminal 101 learns the link meta information at the layers below the root meta information 902 from the attribute and the attribute value, such as the type and the priority of the meta information as the reference destinations contained in the meta reference information 903.

Upon accessing the link meta information 904 from the root meta information 902 in accordance with the meta reference information 903, the user terminal 101 learns the link attribute and the attribute value of the link meta information 904.

As shown in FIG. 12, the user terminal 101 accesses the link meta information 904-1 in accordance with the meta reference information 903-1 contained in the root meta information 902. The user terminal 101 thus references the type (“series”) of the link structure and the attribute value (“drama Nobunaga”) contained in the link meta information 904-1.

By referencing the link meta information 904-1, the root meta information 902 is linked to the branch meta information 905-1 and the branch meta information 905-2 in terms of series as a serial drama program. The series is linked by a specific name called “drama Nobunaga”.

The link meta information 904 is not present in the link structure of the meta information of FIG. 11, and the user terminal 101 is unable to learn the attribute and the attribute value represented as the type of the link structure until the user terminal 101 accesses the branch meta information 905-1 and the branch meta information 905-2 one by one.

The attribute and the attribute value represented as the type of the link structure contained in the link meta information 904 can be contained in the meta reference information 903 of the root meta information 902 of FIG. 11. With this arrangement, however, the root meta information 902 increases in data size, thereby degrading access efficiency, and leading to a low search efficiency.

By shifting the attribute and the attribute value contained in one of the root meta information 902 and the branch meta information 905 to the link meta information 904, the access efficiency to the root meta information 902 is increased. The user terminal 101 can thus access efficiently to target branch meta information 905 by referencing the link meta information 904 rather than by accessing all branch meta information 905.

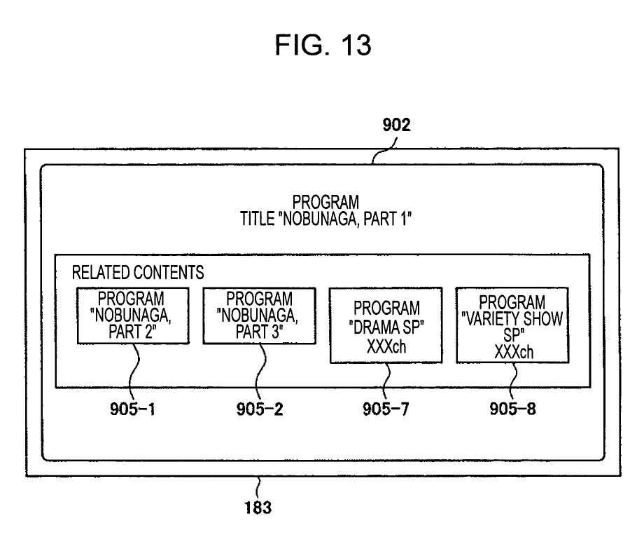

A display example presented on the display screen of the user terminal 101 of the present embodiment is described below with reference to FIG. 13. FIG. 13 diagrammatically illustrates the display of the meta information presented on the display screen.

As shown in FIG. 13, the display screen of the display 183 of the user terminal 101 displays the program meta information (a title “Nobunaga, part 1”) as the root meta information, and the branch meta information linked to the root meta information. While the root meta information is linked to the branch meta information via the link meta information, the root meta information can also be directly linked to the branch meta information. The display example of FIG. 13 is based on the link structure of the meta information of FIG. 11 or 12.

The display 183 displays, in the display example of FIG. 13, branch meta information 905-1 (program “Nobunaga, part 2”) having a priority of 1 as shown in FIG. 11 or 12, branch meta information 905-2 (program “Nobunaga, part 3”), branch meta information 905-7 (program “drama SP”), and branch meta information 905-8 (program “variety show SP”).

The branch meta information 905 satisfying a display condition of a priority of “1” is displayed in the display example of FIG. 13. The present invention is not limited to this setting. The priority can be “2”, “3”, or “1 to 2”, for example.

The priority attribute is referenced as a display condition in the display example of FIG. 13. The present invention is not limited to the priority attribute. For example, the “same subject” or “person” in the type of the meta information can be referenced as the display condition. Alternatively, a combination of the priority and the meta information may be referenced as a display condition.

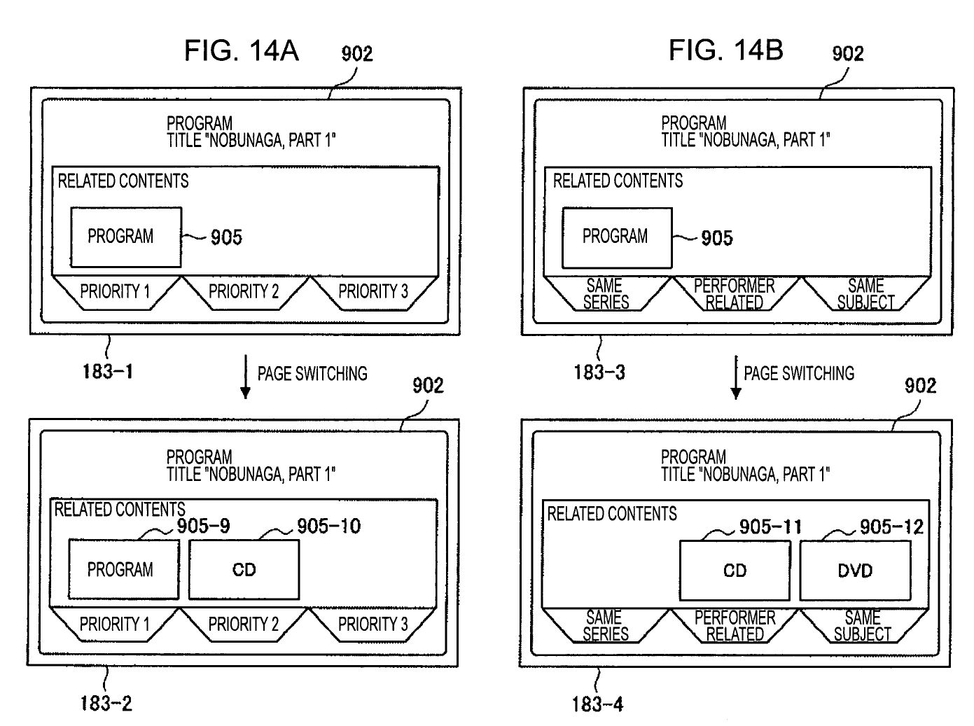

A first modification of the display example of FIG. 13 is described below with reference to FIGS. 14A and 14B. FIGS. 14A and 14B diagrammatically illustrate the first modification of the display example of FIG. 13. Elements identical to those described with reference to FIG. 13 are designated with the same reference numerals and only a difference between the two display examples is described here.

As shown in FIG. 14A, the root meta information 902 and the branch meta information 905 linked to the root meta information 902 are displayed on a screen of a display 183-1. Tabs “priority 1”, “priority 2”, and “priority 3” are displayed in the display screen.

Since the tab “priority 1” is displayed as being active on the display 183-1 of FIG. 14A, the branch meta information 905 (program) has a priority of “1”.

If a user selects a priority tab using a mouse as the input unit 181, the branch meta information 905 corresponding to the selected priority appears on the display screen. When the “priority 2” tab is selected on the screen of the display 183-2 of FIG. 14A, the display screen is switched to a page, displaying branch meta information 905-9 and branch meta information 905-10, each with a priority of “2”.

By comparison of a display 183-3 of FIG. 14B with the display 183-1 of FIG. 14A, the display 183-3 displays tabs for “same series”, “performer related”, and “same subject”, different from the tabs for the priorities in the display 183-1.

Since the tab “same series” is displayed as being active in the display 183-3 of FIG. 14B, the branch meta information 905 (program) having the “same series” as the type of the link meta information is displayed.

If the user selects a displayed tab using a mouse as the input unit 181, the branch meta information 905 corresponding to the attribute or the attribute value of the selected tab appears on the display screen. If the tab “performer related” is selected in the screen of the display 183-4 of FIG. 14B, the display screen is switched to a page, displaying branch meta information 905-11 and branch meta information 905-12, corresponding to the “performer related” as the type of the link meta information.

As described above, the tabs for displaying the branch meta information corresponding the attribute and the attribute value of the link meta information are displayed on the display screen of the present embodiment. The present invention is not limited to this arrangement. For example, symbols, such as icons, may be used for the attribute and the attribute value, or each of the attribute and the attribute value may be used as is.

A single piece of the program meta information is displayed on the display screen in the above discussion. Alternatively, a plurality of pieces of program meta information may be arranged in respective outlined frames as in a program guide.

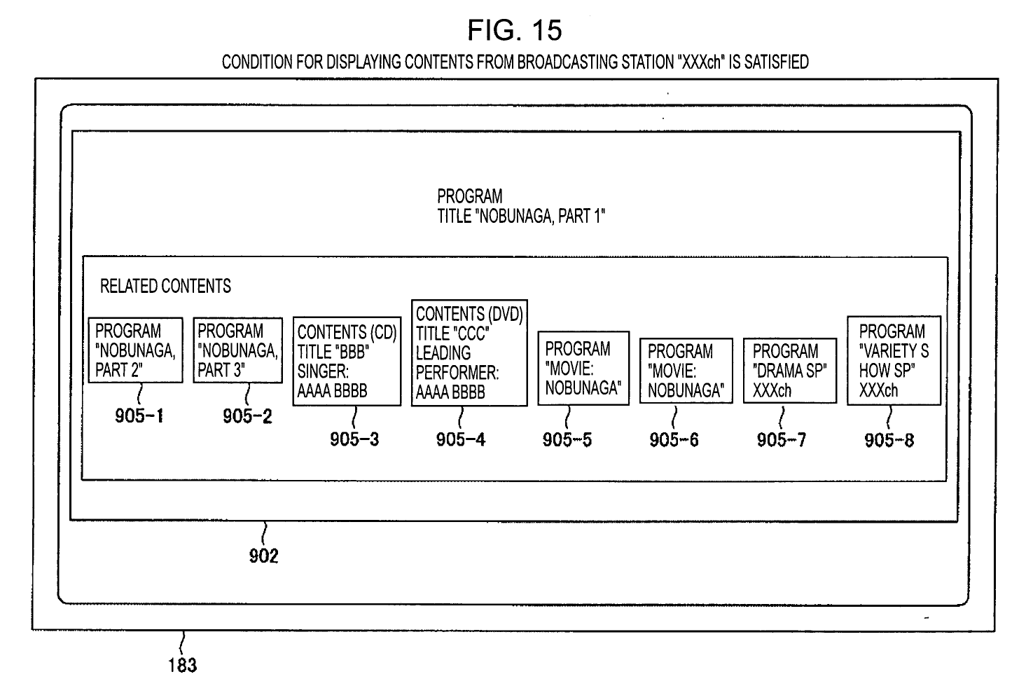

A second modification of the display example of FIG. 13 is described below with reference to FIG. 15. FIG. 15 diagrammatically illustrates the second modification of the display example of FIG. 13. In FIG. 15, elements described with reference to FIG. 13 are designated with the same reference numerals and only a difference between the two display examples is described below. The display example of FIG. 15 is based on the link structure of the meta information of FIG. 11 or 12.

The root meta information as the root meta information 902 and the branch meta information 905 linked to the root meta information 902 are displayed on the display screen of the display 183 as shown in FIG. 15.

At least one ECG service provider apparatus 105 is presented on a per channel basis. The ECG service provider apparatuses 105 respectively operating channels XXXch and YYYch are present.

The TV video channel on the screen is the XXXch and the user terminal 101 requests the ECG service provider apparatus 105 of the channel XXXch to provide a program (drama “Nobunaga”, part 1) of the broadcasting station XXXch. As shown in FIG. 15, branch meta information 905 (905-1, 905-2, 905-3, 905-4, 905-5, 905-6, 905-7, and 905-8) is shown on the screen of the display 183.

To display the branch meta information 905 in the display 183 of FIG. 15 in accordance with a linking rule (layout rule), the user terminal 101 checks that the ECG service provider apparatus 105 as an information sender is XXXch identical to the channel of the TV video channel. In the case of XXXch, a rule that the branch meta information 905 is laid out in a template is described. Upon receiving the branch meta information 905, the user terminal 101 displays the received branch meta information 905 on the display screen thereof.

The attribute value indicating the channel XXXch is defined in the program meta information as the root meta information 902 as shown in FIG. 11 or 12. During displaying process of the branch meta information 905, the shaping and converting unit 182 determines that the attribute value of the broadcasting station XXXch is reflected in the branch meta information 905 linked to the program meta information.

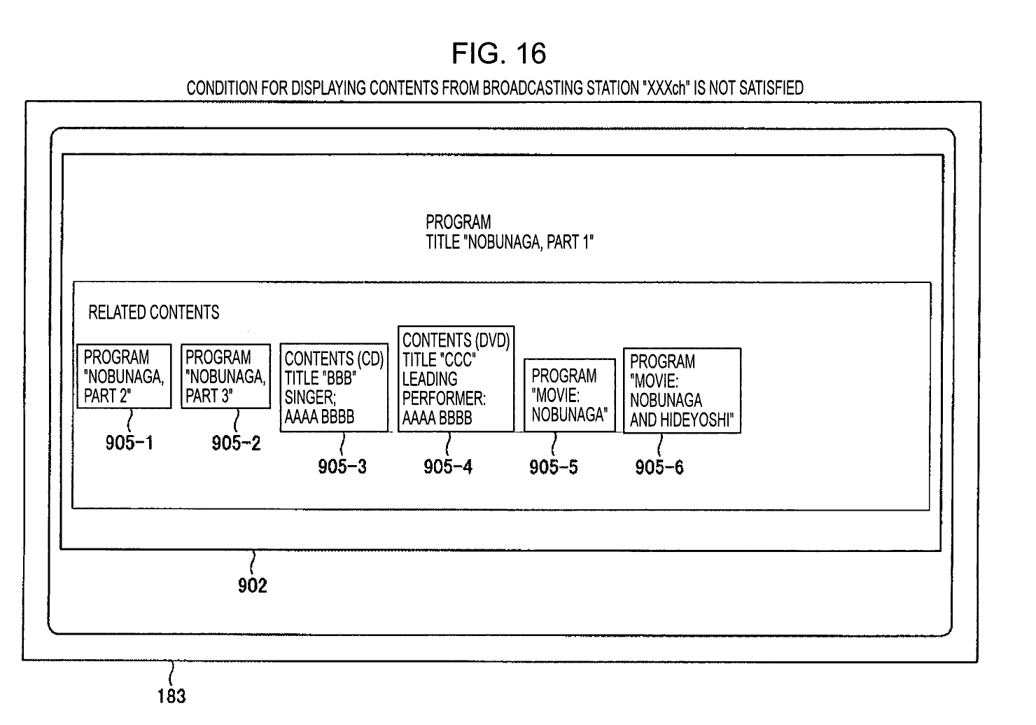

The second modification of the display example of FIG. 13 is described below with reference to FIG. 16. FIG. 16 diagrammatically illustrates the second modification of the display example of FIG. 13. In FIG. 16, elements identical to those described with reference to FIG. 15 are designated with the same reference numerals, and only a difference between the two display examples is described below.

A TV video on a channel YYYch is displayed as being selected. If the user terminal 101 requests the XXXch ECG service provider apparatus 105 to provide a program (drama Nobunaga, part 1) on the broadcasting station XXXch as shown in FIG. 11 or 12, the branch meta information 905 (905-1, 905-2, 905-3, 905-4, 905-5, and 905-6) is displayed on the screen of the display 183.

To display the branch meta information 905 on the display 183 of FIG. 15 in accordance with a linking rule (layout rule), the user terminal 101 checks that the ECG service provider apparatus 105 as an information sender is YYYch identical to the channel of the TV video channel. If it is determined that the ECG service provider apparatus 105 is not YYYch (a channel other than YYYch), the meta reference information 903 contained in the root meta information 902 to be received next is referenced. If the branch meta information 905 satisfies the above condition, a rule that the branch meta information 905 is laid out in a template is described.

Since XXXch ECG site is defined as the linking condition in the meta reference information 903-4 as shown in FIG. 11 or 12, the shaping and converting unit 182 determines, as being not a target, the branch meta information 905-7 and the branch meta information 905-8 different from the TV video on the channel YYYch displayed on the screen. Since the branch meta information other than these pieces of branch meta information are not defined in the meta reference information 903, the shaping and converting unit 182 determines the branch meta information other than these pieces of branch meta information as a target to be displayed.

The shaping and converting unit 182 in the user terminal 101 lays out the branch meta information 905 in the template on the display screen of the display 183 as shown in FIGS. 15 and 16. Alternatively, the ECG service provider apparatus 105 on the provider side may include the shaping and converting unit 182, and the ECG service provider apparatus 105 may determine whether to display the branch meta information 905 in accordance with a guideline of the provider side such as the broadcasting station.

ECG sites (ECG service provider apparatuses 105) may be present for XXXch and YYYch, respectively, and the same data, such as the program meta information of FIG. 11 or 12 is provided by each of the XXXch ECG service provider apparatus 105 and the YYYch ECG service provider apparatus 105.

If the user terminal 101 acquires the meta information from the XXXch ECG service provider apparatus 105, all branch meta information 905 linked to the root meta information 902 is displayed. If the user terminal 101 acquires the meta information from the YYYch ECG service provider apparatus 105, the display data generated with the branch meta information 907 and the branch meta information 908 not laid out in the template is received and displayed on the display screen.

The YYYch ECG service provider apparatus 105 has the same data as the XXXch ECG service provider apparatus 105. Since “only XXXch ECG site” is set in the “condition of link” in the meta reference information 903-4, the shaping and converting unit 182 has no right to select the branch meta information on the XXXch because of the YYYch in the laying out of the branch meta information in the template. The branch meta information 907 and the branch meta information 908, linked to the meta reference information 903-4, are not included as a target and are not laid out in the template. In the above discussion, the attribute is “only XXXch ECG site”. Alternatively, the attribute may be an ECG service ID for identifying the ECG service provider apparatus 105 (ECG site).

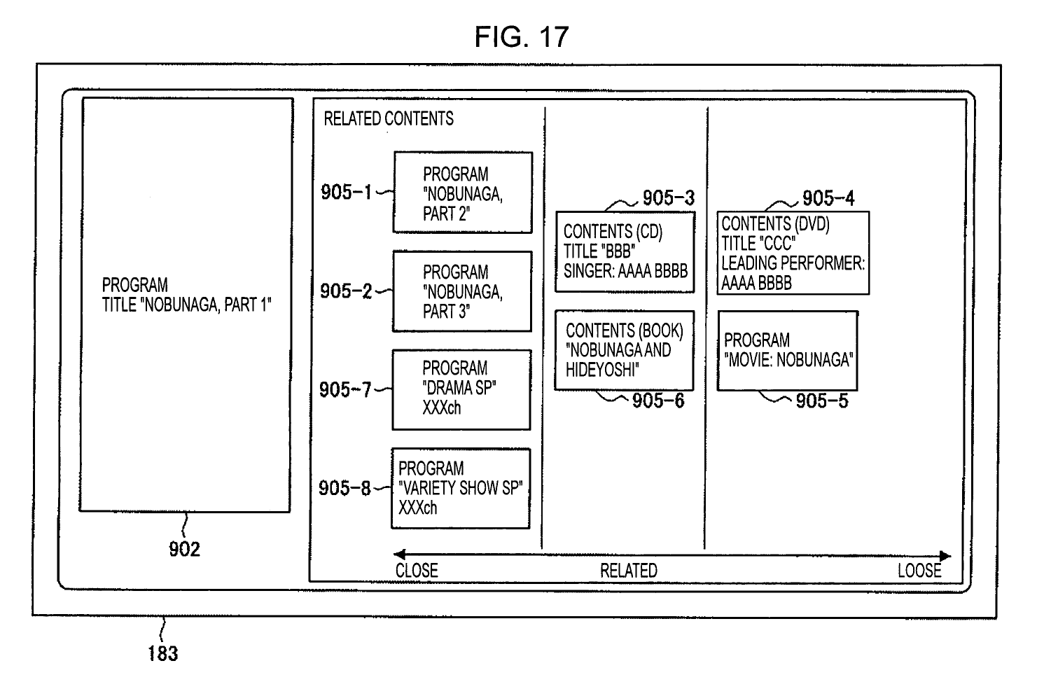

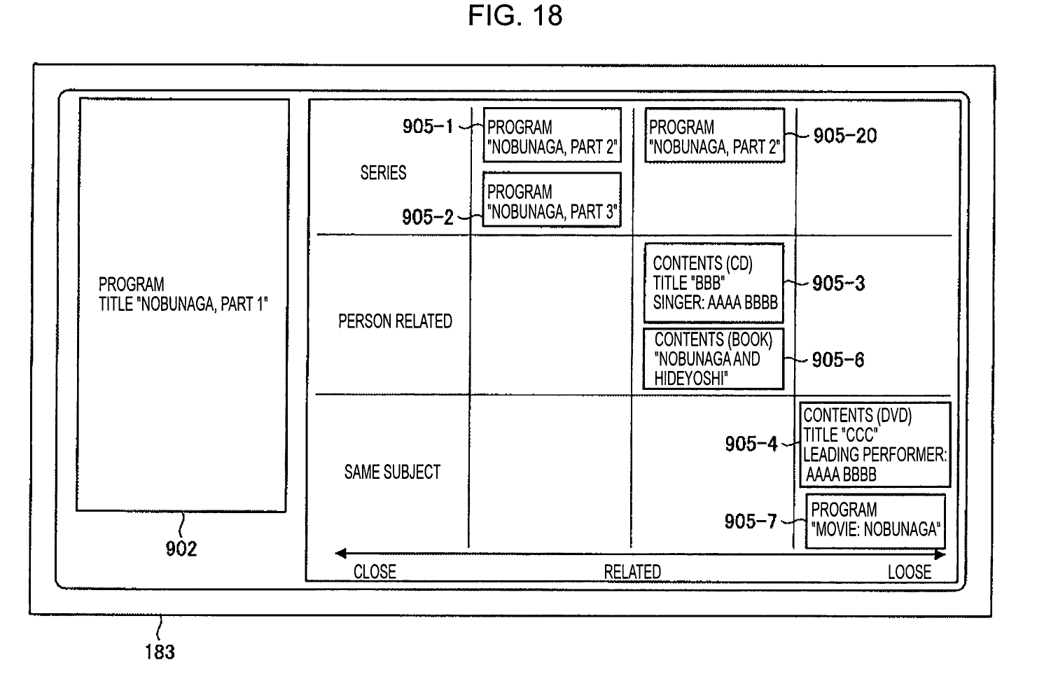

A third modification of the display example of FIG. 13 is described below with reference to FIG. 17. FIG. 17 diagrammatically illustrates the third modification of the display example of FIG. 13. In FIG. 17, elements identical to those described with reference to FIG. 13 are designated with the same reference numerals, and only a difference between the two display examples is described below. The display example of FIG. 17 is based on the link structure of the meta information of FIG. 11 or 12.

As shown in FIG. 17, the program meta information as the root meta information 902 and the branch meta information 905 linked to the root meta information 902 are displayed on the display screen of the display 183. A display layout of FIG. 17 is different from that of FIG. 13.

The degree of relation to the root meta information 902 is shown along a horizontal axis on the display screen of FIG. 17. The degree of relation becomes close as it goes horizontally leftward, and becomes loose at it goes horizontally rightward.

The shaping and converting engine 401 in the shaping and converting unit 182 determines the degree of relation from the attribute and the attribute value of the link meta information and the meta reference information 903 when the display is generated from the template. The branch meta information 905 is thus laid out at an appropriate location in the template.

As shown in FIG. 17, the branch meta information 905-1, the branch meta information 905-2, the branch meta information 905-7, and the branch meta information 905-8 are displayed on the screen of the display 183 as being closely related. The branch meta information 905-1, the branch meta information 905-2, etc. are closely related. This is because the title of the program meta information of the root meta information 902 is “drama Nobunaga, part 1”, the meta reference information 903-1 thereof is the “same series”, and the attribute value of the type of the link meta information 904-1 partially coincides with the “drama Nobunaga”, and the title of the program. These pieces of information are thus most closely related to each other.

The degree of relation is represented by a horizontal axis as shown in FIG. 17. Alternatively, the degree of relation may be represented by the size of icons (with a larger icon representing a more closely related state), by the lightness level of the branch meta information 905 (with black representing a closely related state, white representing a loosely related state, and an intermediate density representing an intermediate related state, for example). Alternatively, the degree of relation is represented by a distance from a given center, for example, with a point closer to the center representing a more closely related state. In this case, the distance is not only measured along a fixed linear straight line but measured from the center in a two-dimensional fashion.

A modification of the display example of FIG. 17 is described below with reference to FIG. 18. FIG. 18 diagrammatically illustrates the modification of the display example of FIG. 17. In FIG. 18, elements identical to those described with reference to FIG. 17 are designated with the same reference numerals, and only a difference between the display examples is described below.

As shown in FIG. 18, the program meta information as the root meta information 902 is displayed on the display screen of the display 183. Furthermore, the branch meta information 905 linked to the root meta information 902 is also displayed on a per attribute or attribute value basis. The branch meta information 905 is displayed according to only the degree of relation.

The degree of relation is represented by a horizontal axis as shown in FIG. 18. Alternatively, the degree of relation may be represented by the size of icons (with a larger icon representing a more closely related state), by the lightness level of the branch meta information 905 (with black representing a closely related state, white representing a loosely related state, and an intermediate density representing an intermediate related state, for example), or by transparency (with a high degree of transparency representing a more closely related state).

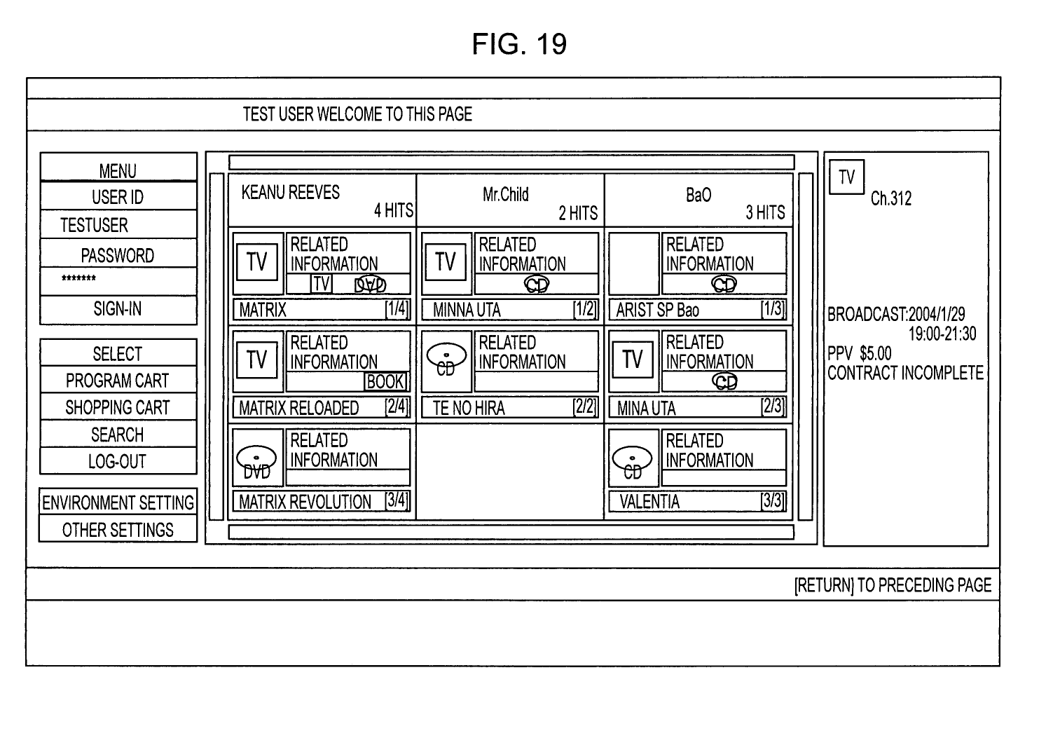

A fourth modification of the display example of FIG. 13 is described below with reference to FIGS. 19-21. FIGS. 19-21 illustrate the fourth modification of the display example of FIG. 13. In FIGS. 19-21, elements identical to those described with reference to FIG. 13 are designated with the same reference numerals and only a difference from the display example of FIG. 13 is described below.

A plurality of pieces of program meta information as the root meta information 902, for example, a program guide, is displayed on the display screen of the display 183 of FIG. 19. The program guide is composed a plurality of pieces of meta information displayed on the display 183 of the user terminal 101 in the ECG service.

A keyword, such as “Keanu Reeves”, related to a program, related information (content meta information), such as “TV” or “CD” related to the program, are displayed on the display screen. Also displayed are a category icon indicating the category of the related information and s scroll bar for scrolling the display screen. Displayed on the right-hand portion of the display screen is supplementary information supplementing a program selected by the input unit 181.

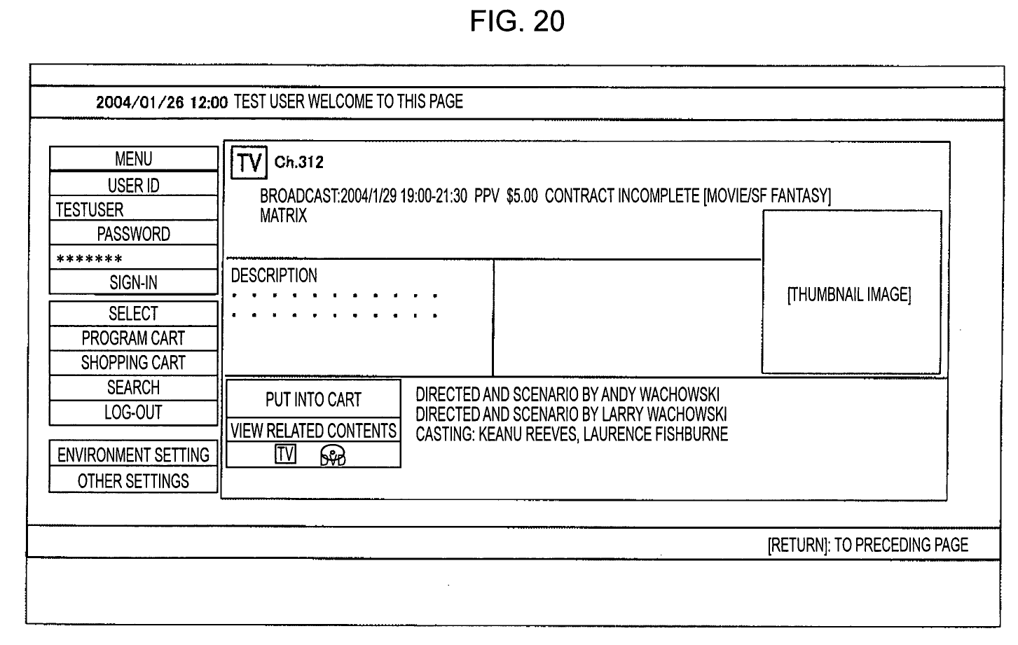

The content information related to the program selected by the input unit 181 is displayed on the display screen of the display 183 of FIG. 20. The content information is the branch meta information 905 in the layer below the program meta information as the root meta information 902. Accessing to the branch meta information 905 (content information) from the program meta information has previously been discussed.

The content meta information is displayed as the display data by the shaping and converting unit 182 through a display production process thereof. The thumbnail image of the program and the category icon representing the category of a related content currently present are displayed on the display screen as shown in FIG. 20.

The user may select a “put into cart” icon using the input unit 181. If the program meta information is displayed, the user can make a contract for PPV (pay per view) online. If the content meta information for books, for example, is displayed, the user can purchase a book displayed in the content meta information online.

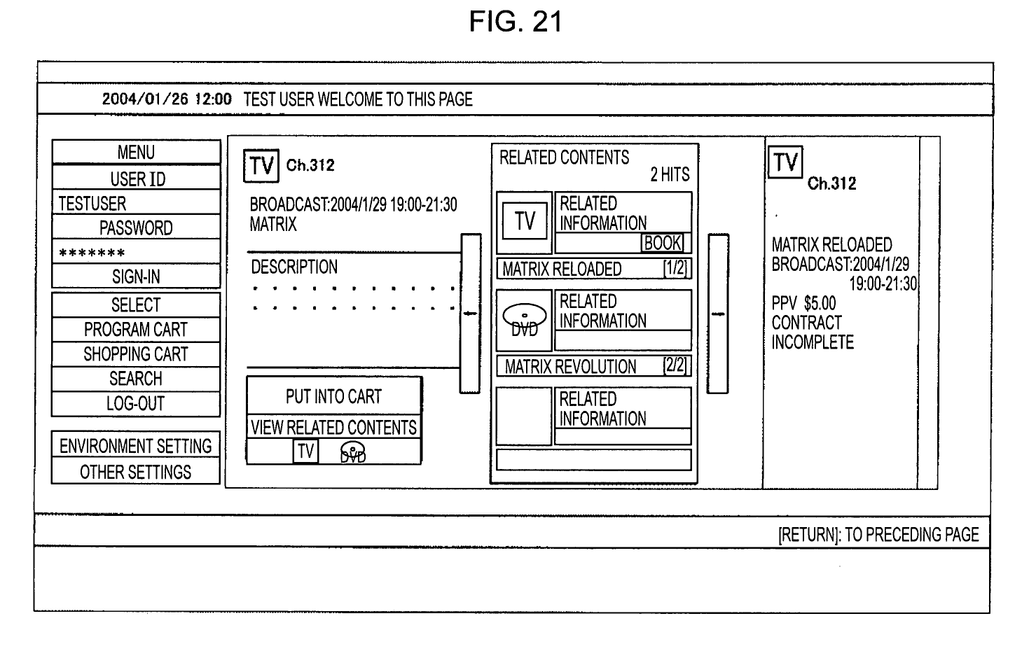

If a category icon displayed in a “view related contents” box of FIG. 20 is selected as shown in FIG. 21 using the input unit 181, a list of related contents is displayed on the display screen of FIG. 20. More specifically, the list of the related contents is displayed as a new layer on the display screen of FIG. 21. By selecting a tab (not shown), the branch meta information displayed in the related contents is switched by priority. The branch meta information is switched using a display switch button such as a scroll bar or an arrow button.

The content information related to the selected program is displayed on the display screen of the display 183 as shown in FIG. 20. Alternatively, the detailed information of the selected program may be displayed on the display screen. The detailed information of the selected program is displayed and the category icon displayed in the “view related contents” box is displayed. By selecting a desired one from among category icons, the detailed information of the content information corresponding to the selected category icon is displayed.

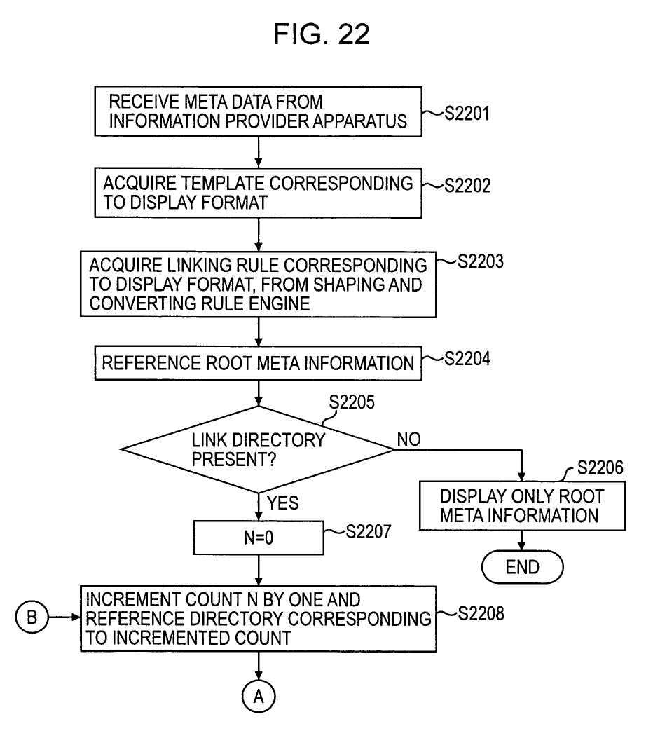

A generation process of the display data displayed on the display screen of the display 183 is described below with reference to FIGS. 22-24. FIGS. 22-24 are flowcharts of the generation process of the display data displayed on the display screen.

Upon receiving meta data from the ECG service provider apparatus 105 via the network 103 as shown in FIG. 22, the user terminal 101 supplies the meta data to the shaping and converting unit 182 therewithin (step S2201).

Upon receiving the meta data, the shaping and converting unit 182 acquires a template appropriate for a display size of the display 183 of the user terminal 101 (step S2202).

A linking rule (layout rule), for generating the display data, prepared on a per template basis, is acquired from the shaping and converting rule engine 403 in the shaping and converting unit 182 (step S2203).

Available as the linking rules are a rule predetermined for a display size of the display screen and a rule set by the user for each environmental setting. For example, the rules may be stored as user meta information in one of the ECG service provider apparatus 105 and the user terminal 101.

Upon receiving the linking rule (step S2203), the shaping and converting engine 401 references the root meta information (step S2204).

By referencing the meta reference information from the root meta information and the attribute and the attribute value of the root meta information, the shaping and converting engine 401 determines whether the link meta information is present (step S2205).

If it is determined in step S2205 that the link meta information is present, the shaping and converting engine 401 initializes a counter (step S2207). The shaping and converting engine 401 increments the counter by 1 and reference the link meta information in response to the meta reference information corresponding to the count. The count of the counter and the sequential order of the meta reference information are in one-to-one correspondence.

If it is determined in step S2205 that no link meta information is present, the shaping and converting engine 401 generates the display data by laying out only the root meta information in the template, and ends the process. The display data is displayed on the display 183.

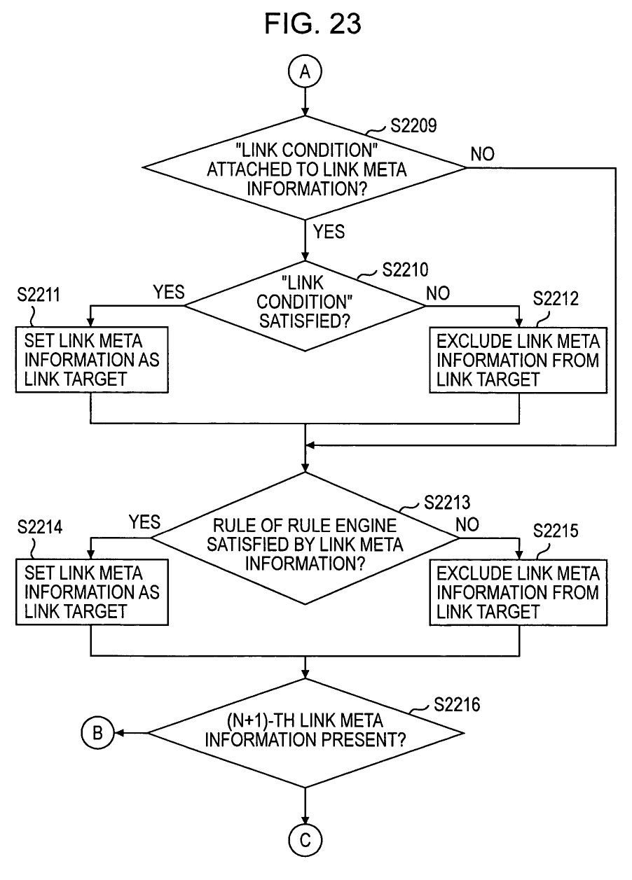

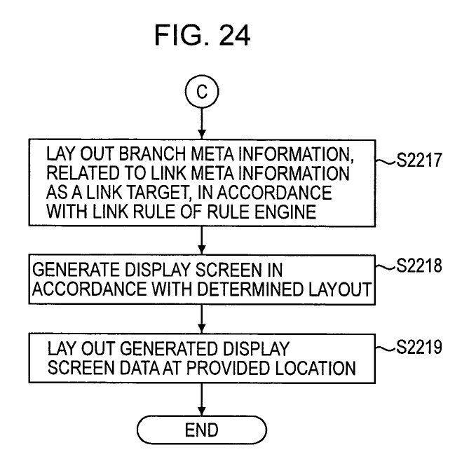

As shown in FIG. 23, the shaping and converting engine 401 checks the presence or absence of the attribute and the attribute value of the type and condition of link of the link meta information.

If it is determined in step S2210 that the attribute and the attribute value of the link meta information are satisfied, the link meta information is set to be a target for link (step S2211). If it is determined in step S2210 that the attribute and the attribute value of the link meta information are not satisfied, the link meta information is excluded from a target link candidate (step S2212).

The shaping and converting engine 401 compares the attribute and the attribute value with the linking rule to determine whether the attribute and the attribute value satisfy the condition of the linking rule (step S2213). If it is determined that the attribute and the attribute value satisfy the condition of the linking rule, the shaping and converting engine 401 sets the link meta information as a link target. If it is determined that the attribute and the attribute value fail to satisfy the condition of the linking rule, the shaping and converting engine 401 excludes the link meta information from a link target candidate (step S2215). If the link meta information set as a link target in step S2210 is determined as failing to satisfy the condition in step S2213, the link meta information is excluded as a link target candidate.

When determining whether the attribute and the attribute value satisfy the linking rule (step S2213), the shaping and converting engine 401 checks whether the branch meta information 905 is within a total amount of information (data) displayable on the display screen size of the user terminal 101. The total amount of data is the sum of the branch meta information. The total amount of data may be the sum of the data of all branch meta information and the data of image data, for example, present in a link destination (over a net) described in the branch meta information.

The shaping and converting engine 401 references the branch meta information 905 linked to each of the acquired link meta information 904. The shaping and converting engine 401 thus determines the amount of data of the branch meta information 905, linked to the root meta information, on a per piece of link meta information. If the determined amount of data is above an amount of data predetermined for each template, the link meta information is excluded as a link target candidate.

The amount of data may be above the total amount of information displayable. In such a case, within a limit of an amount of data displayable on the display screen, the shaping and converting engine 401 lays out the branch meta information, linked to the link meta information, in the display area of the template in the order from small to large amount of the sum of data amount of the branch meta information in the layer below the link meta information. Since the branch meta information is laid out in the order of small to large amount, more types of branch meta information are displayed on the display screen.

If the amount of data is above the amount of data predetermined for the template, the link meta information is excluded from a target link range. Alternatively, branch meta information 905 having the highest priority, from among the branch meta information excluded from a target link range, may be laid out in the template. The excluded link meta information may be set to be a next display candidate in response to page switching.

The shaping and converting engine 401 increments the counter by 1, and determines the presence of the link meta information from the meta reference information corresponding to the count of the counter (next meta reference information subsequent to the meta reference information).

If it is determined in step S2216 that the link meta information is present, the shaping and converting engine 401 performs a reference process of the link meta information of FIG. 22 (step S2208) and then next processes.

If it is determined in step S2216 that the link meta information is not present, the shaping and converting engine 401 acquires the branch meta information in accordance with the link meta information determined as a link target candidate as shown in FIG. 24. In accordance with the acquired linking rule, the branch meta information is laid out in the template (step S2217).

Subsequent to the layout, the shaping and converting engine 401 generates the display data in accordance with the branch meta information laid out in the template (step S2218).

The generated display data is displayed on the display screen of the display 183 (step S2219).

When the meta information is laid out in accordance with the linking rule, the display example displayed on the display screen of the display 183 becomes the ones similar to those discussed with reference to FIGS. 13-21.

The generation process of the display data has been discussed. In the above discussion, the shaping and converting unit 182 for generating the display data is included in the user terminal 101. Alternatively, the shaping and converting unit 182 may be arranged in the information provider apparatus 104.

When the root meta information is linked to the branch meta information, the content of link (such as the priority and the condition of link) may be set as the attribute and the attribute value in the link meta information. The information provider can increase a chance of being viewed by target users, and the users can efficiently and quickly search a great deal of information for target information.

Once the link meta information is produced, the same link meta information can be reused. For example, the root meta information is linked so that link meta information produced by a broadcasting station A is referenced by another broadcasting station B.

When the link meta information is reused, the attribute and the attribute value of the meta reference information of the root meta information may be set. In this way, the meta information is linked in a manner that meets an purpose and a guideline of the information provider.

The shaping and converting unit 182 is implemented in hardware in the above discussion. The present invention is not limited to the hardware arrangement. For example, the shaping and converting unit 182 may be implemented in a application software program composed of one of a program module and a program component.

The memory 184 is composed of a single hardware disk in the above discussion. The present invention is not limited to the hardware disk. An external hard disk may be arranged. The memory 184 may further include at least one of a random-access memory (RAM), a read-only memory (ROM), and a flash memory.

It should be understood by those skilled in the art that various modifications, combinations, sub-combinations and alterations may occur depending on design requirements and other factors insofar as they are within the scope of the appended claims or the equivalents thereof.

1. A user terminal for displaying a content, comprising:
a root meta information acquisition unit acquiring root meta information, belonging to a first layer, from among meta information for displaying one of a program and a content related to the program;
a link meta information acquisition unit linking the root meta information to at least one piece of branch meta information under the layer of the root meta information, and acquiring link meta information containing link attribute indicating a common link from among other links;
a template selecting unit selecting one template from among at least one template defining a layout position where the meta information is laid out in a display area of a display screen; and
a layout unit selecting a layout rule, for laying out the meta information, in accordance with the selected template and laying out one of the root meta information and the link meta information in the display area of the template based on the layout rule and the link attribute.

2. The user terminal according to claim 1, wherein the layout unit lays out the link meta information and/or the branch meta information in the display area of the template in accordance with priority information contained in the root meta information and representing a priority according to which the meta information is laid out in the template.

3. The user terminal according to claim 1, wherein the layout unit determines a total amount of branch meta information linked to the root meta information from the acquired link meta information and if the total amount of branch meta information is above a total amount of information displayable on the display screen, lays out, in the template, the branch meta information pointed by the link meta information, in the order from small to large amount of data, within a limit not exceeding the total amount of information displayable on the display screen.

4. The user terminal according to claim 2, wherein the layout unit determines a total amount of branch meta information linked to the root meta information from the acquired link meta information and if the total amount of branch meta information is above a total amount of information displayable on the display screen, lays out, in the template, the branch meta information pointed by the link meta information, in the order from high to low priority of data, within a limit not exceeding the total amount of information displayable on the display screen.

5. The user terminal according to claim 1, wherein the link attribute contained in the link meta information comprises at least one of a type of a link and a condition satisfying the link.

6. A user terminal for displaying a content, comprising:
a root meta information acquisition unit acquiring root meta information, belonging to a first layer, from among meta information for displaying one of a program and a content related to the program;
a template selecting unit selecting one template from among at least one template defining a layout position where the meta information is laid out in a display area of a display screen; and
a layout unit selecting a layout rule, for laying out the meta information, in accordance with the selected template and laying out one of the root meta information and branch meta information in the display area of the template in accordance with the selected layout rule and common attribute information of common branch meta information from among at least one piece of branch meta information under the layer of the root meta information, the common attribute information being generated according to attribute unit.

7. The user terminal according to claim 6, wherein the layout unit lays out one of the root meta information and the branch meta data in the display area of the template in accordance with priority information contained in the common attribute information and representing a priority according to which the meta information is laid out in the template.

8. The user terminal according to claim 7, wherein the layout unit determines a total amount of at least one piece of branch meta information, pointed by the common attribute information, on a per piece of common attribute information basis, the common attribute information contained in a single piece of root meta information, and if the total amount of branch meta information is above a total amount of information displayable on the display screen, lays out one of the root meta information and the branch meta information, in the order from high to, low priority of data, within a limit not exceeding the total amount of information displayable on the display screen.

9. A method for generating display data on a user terminal displaying a content, the method comprising steps of:
acquiring root meta information, belonging to a first layer, from among meta information for displaying one of a program and a content related to the program;
linking the root meta information to at least one piece of branch meta information under the layer of the root meta information;
acquiring link meta information containing link attribute indicating a common link from among other links;
selecting one template from among at least one template defining a layout position where the meta information is laid out in a display area of a display screen;
selecting a layout rule, for laying out the meta information, in accordance with the selected template;
and laying out one of the root meta information and the link meta information in the display area of the template based on the layout rule and the link attribute.

10. The method according to claim 9, wherein the layout step comprises laying out the link meta information and/or the branch meta information in the display area of the template in accordance with priority information contained in the root meta information and representing a priority according to which the meta information is laid out in the template.

11. The method according to claim 9, wherein the layout step comprises determining a total amount of branch meta information linked to the root meta information from the acquired link meta information and if the total amount of branch meta information is above a total amount of information displayable on the display screen, laying out, in the template, the branch meta information pointed by the link meta information, in the order from small to large amount of data, within a limit not exceeding the total amount of information displayable on the display screen.

12. The method according to claim 10, wherein the layout step comprises determining a total amount of branch meta information linked to the root meta information from the acquired link meta information and if the total amount of branch meta information is above a total amount of information displayable on the display screen, laying out, in the template, the branch meta information pointed by the link meta information, in the order from high to low priority of data, within a limit not exceeding the total amount of information displayable on the display screen.

13. The method according to claim 9, wherein the link attribute contained in the link meta information comprises at least one of a type of a link and a condition satisfying the link.

14. A method for generating display data on a user terminal displaying a content, the method comprising steps of:
acquiring root meta information, belonging to a first layer, from among meta information for displaying one of a program and a content related to the program;
selecting one template from among at least one template defining a layout position where the meta information is laid out in a display area of a display screen;
selecting a layout rule, for laying out the meta information, in accordance with the selected template;
and laying out one of the root meta information and branch meta information in the display area of the template in accordance with the selected layout rule and common attribute information of common branch meta information from among at least one piece of branch meta information under the layer of the root meta information, the common attribute information being generated according to attribute unit.

15. The method according to claim 14, wherein the layout step comprises laying out one of the root meta information and the branch meta data in the display area of the template in accordance with priority information contained in the common attribute information and representing a priority according to which the meta information is laid out in the template.

16. The method according to claim 15, wherein the layout step comprises determining a total amount of at least one piece of branch meta information, pointed by the common attribute information, on a per piece of common attribute information basis, the common attribute information contained in a single piece of root meta information, and if the total amount of branch meta information is above a total amount of information displayable on the display screen, laying out one of the root meta information and the branch meta information, in the order from high to low priority of data, within a limit not exceeding the total amount of information displayable on the display screen.

17. A computer program for causing a user terminal to generate display data, the computer program comprising steps of:
acquiring root meta information, belonging to a first layer, from among meta information for displaying one of a program and a content related to the program;
linking the root meta information to at least one piece of branch meta information under the layer of the root meta information;
acquiring link meta information containing link attribute indicating a common link from among other links;
selecting one template from among at least one template defining a layout position where the meta information is laid out in a display area of a display screen;
selecting a layout rule, for laying out the meta information, in accordance with the selected template;
and laying out one of the root meta information and the link meta information in the display area of the template, based on the layout rule and the link attribute.

18. A computer program for causing a user terminal to generate display data, the computer program comprising steps of:
acquiring root meta information, belonging to a first layer, from among meta information for displaying one of a program and a content related to the program;
selecting one template from among at least one template defining a layout position where the meta information is laid out in a display area of a display screen;
selecting a layout rule, for laying out the meta information, in accordance with the selected template;
and laying out one of the root meta information and the branch meta information in the display area of the template in accordance with the selected layout rule and common attribute information of common branch meta information from among at least one piece of branch meta information under the layer of the root meta information, the common attribute information being generated according to attribute unit.
